(19) United States
(12) Patent Application Publication
(10) Pub. No.: US 2012/0137448 A1
(43) Pub. Date: Jun. 7, 2012

(54) CARE COMPOSITIONS

(76) Inventors: Rajan Keshav Panandiker, West Chester, OH (US); Bernard William Kluesener, Harrison, OH (US); Renae Dianna Fossum, Middletown, OH (US); Heather Anne Doria, Hamilton, OH (US); Lenae Virginia Johnson, Cincinnati, OH (US); Alessandro Corona, III, Mason, OH (US)

(21) Appl. No.: 13/308,578

(22) Filed: Dec. 1, 2011

Related U.S. Application Data
(60) Provisional application No. 61/418,626, filed on Dec. 1, 2010.
(60) Provisional application No. 61/418,594, filed on Dec. 1, 2010.
(60) Provisional application No. 61/418,603, filed on Dec. 1, 2010.

(51) Int. Cl. C11D 3/60; D06L 1/00

(52) U.S. Cl. 8/137; 510/515; 510/516; 510/527; 510/517

(57) ABSTRACT

The instant disclosure relates to methods of making compositions comprising polyglycerol esters (PGEs) and a fabric softening active. Such compositions and methods of using such compositions are also disclosed. Such compositions have a structural state designed to include a significant amount swollen lamellar bi-layers comprising a combination of a plurality of softener actives. Thus, the composition has a thermodynamically favorable state that minimizes certain drawbacks and allows additional advantages to be obtained.

### CROSS-REFERENCES TO RELATED APPLICATIONS

This application claims priority under 35 U.S.C. §119(e) to U.S. Provisional Application Ser. No. 61/418,626 filed Dec. 1, 2010, U.S. Provisional Application Ser. No. 61/418,594 filed Dec. 1, 2010, and U.S. Provisional Application Ser. No. 61/418,603 filed Dec. 1, 2010.

### FIELD OF THE INVENTION

The instant disclosure relates to compositions comprising polyglycerol esters (PGEs) and, a fabric softening active and methods of making and using same.

### BACKGROUND OF THE INVENTION

Fluid fabric enhancers are used by consumers to soften and freshen articles comprising fabrics, such as garments. While such fabric enhancers provide such benefits, such benefits come with drawbacks that include: less than desired shelf stability, processing complexity arising from the tight processing energy window needed to convert the fabric softening active into a pourable and dispersible liquid, a narrow pH range arising from the use of biodegradable fabric softening active(s), and raw material compatibility constraints arising from interactions between actives. Thus, what is needed is a stable, easily processed fluid fabric enhancer having minimal raw material compatibility constraints.

Applicants recognized that the source of such drawbacks lay in the structural state of current fluid fabric enhancers. Current fluid fabric enhancers typically exist in a state wherein their actives, such as cationic fabric softening actives and fatty amphiphiles, are primarily separate liquid dispersions comprising vesicles, lamellar fragments and crystalline dispersions. Applicants recognized that as such liquid dispersions are separate and as their microstructures, comprise vesicles, lamellar fragments and crystalline dispersions, such dispersions lead to the aforementioned drawbacks. While not being bound by theory, Applicants' believe that this is due to the thermodynamically unfavorable nature of such separate dispersions and their microstructures.

Applicants discovered that if the structural state of a fluid fabric enhancer was designed to include a significant amount swollen lamellar bi-layers comprising a combination of a plurality of fabric softening actives, the fluid fabric enhancer was in a thermodynamically favorable state and the aforementioned drawbacks were minimized and additional advantages where obtained. Such additional advantages include: the active level could be lowered and softness performance could be maintained, perfume release, initially and with time, is improved and the rate of hydrolysis, for ester quats, is decreased, thus the fluid fabric enhancers' stability is improved. Such stability improvement is particularly noted at temperature of 35° C. or greater. Furthermore, such fluid fabric enhancers may be perceived to have improved aesthetics. Finally, Applicants recognized that compositions having the desired microstructures and thus the aforementioned benefits, have at least one melt transition temperature, two melt transition temperatures or even three melt transition temperatures that are at least 3° C., from 3° C. to about 20° C., from about 5° C. to about 15° C., or even from about 5° C. to about 12° C. higher than the melt transition temperature of individual dispersions of any cationic fabric softening active or amphiphile that is employed in said fluid fabric softener. Thus, Applicants' compositions can be characterized by the compositions' components and such melt transition temperatures.

Finally, Applicants recognized that such benefits may be achieved by adding a fatty amphiphile directly to a cationic softener active and then combining the mixture of fatty amphiphile and cationic softener active with water. Furthermore, direct addition of the fatty amphiphile to the cationic softening active eliminates a step in the process by eliminating the need to emulsify the fatty amphiphile with a non-ionic surfactant and a material, such as, cetyl-trimethyl ammonium chloride.

### SUMMARY OF THE INVENTION

The present invention attempts to solve one more of the needs described above by providing, in one aspect of the invention, a method of making a fabric care composition comprising the steps of:
a. mixing a molten fabric softener active with a molten mixture of polyglycerol esters to form a first mixture, wherein each polyglycerol ester in the mixture of polyglycerol esters has the structure of Formula I

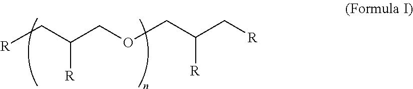

wherein each R is independently selected from the group consisting of fatty acid ester moieties comprising carbon chains having a carbon chain length of from about 10 to about 22 carbon atoms; OH; and combinations thereof;
wherein the mixture of polyglycerol esters has an average value of n ranging from about 1.5 to about 6;
wherein the mixture of polyglycerol esters has an average % esterification ranging from about 20% to about 100%;
wherein greater than or equal to about 50% of the polyglycerol esters in the mixture of polyglycerol esters have at least two ester linkages;
b. combining the first mixture with water to form a second mixture; and
c. combining the second mixture with a material selected from a delivery enhancing agent, an antifoam agent, a chelant, a preservative, a structurant, a silicone, a phase stabilizing polymer, a perfume, a perfume microcapsule, a dispersant, or a combination thereof to form the fabric care composition.

Another aspect of the invention provides a method of making a fabric care composition comprising the steps of:
a. mixing a fabric softener active with a mixture of polyglycerol esters to form a first mixture, wherein each polyglycerol ester in the mixture of polyglycerol esters has the structure of Formula I

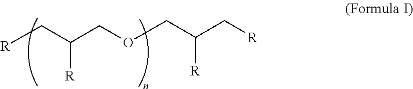

wherein each R is independently selected from the group consisting of fatty acid ester moieties comprising carbon chains having a carbon chain length of from about 10 to about 22 carbon atoms; OH; and combinations thereof;
wherein the mixture of polyglycerol esters has an average value of n ranging from about 1.5 to about 6;
wherein the mixture of polyglycerol esters has an average % esterification ranging from about 20% to about 100%;
wherein greater than or equal to about 50% of the polyglycerol esters in the mixture of polyglycerol esters have at least two ester linkages;
b. melting the first mixture;
c. combining the first mixture with water to form a second mixture; and
d. combining the second mixture with a material selected from a delivery enhancing agent, an antifoam agent, a chelant, a preservative, a structurant, a silicone, a phase stabilizing polymer, a perfume, a perfume microcapsule, a dispersant, or a combination thereof to form the fabric care composition.

Another aspect of the invention provides a method of making a fabric care composition comprising the steps of:
a. melting a fabric softener active;
b. melting a mixture of polyglycerol esters, wherein each polyglycerol ester in the mixture of polyglycerol esters has the structure of Formula I

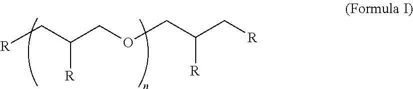

wherein each R is independently selected from the group consisting of fatty acid ester moieties comprising carbon chains having a carbon chain length of from about 10 to about 22 carbon atoms; OH; and combinations thereof;
wherein the mixture of polyglycerol esters has an average value of n ranging from about 1.5 to about 6;
wherein the mixture of polyglycerol esters has an average % esterification ranging from about 20% to about 100%;
wherein greater than or equal to about 50% of the polyglycerol esters in the mixture of polyglycerol esters have at least two ester linkages;
b. simultaneously combining the fabric softening active melt and the polyglycerol ester melt with water to form an aqueous mixture; and
c. combining the aqueous mixture with a material selected from a delivery enhancing agent, an antifoam agent, a chelant, a preservative, a structurant, a silicone, a phase stabilizing polymer, a perfume, a perfume microcapsule, a dispersant, or a combination thereof to form the fabric care composition.

Still other aspects of the invention include methods of using fabric care compositions made according to the method described above, fabric care compositions and treating fabric with these fabric care compositions.

### BRIEF DESCRIPTION OF THE DRAWINGS

FIG. 1 details the Apparatus A used in the method of the present invention.

FIG. 2 details the orifice component 5 of Apparatus A used in the method of the present invention.

FIG. 3 details the Apparatus B used in the process of the present invention

### DETAILED DESCRIPTION OF THE INVENTION

As used herein, the articles “a” and “an” when used in a claim, are understood to mean one or more of what is claimed or described.

As used herein, the terms “include,” “includes,” and “including” are meant to be non-limiting.

As used herein, the term “fluid” includes liquid, gel, and paste product forms.

As used herein, the term “situs” includes paper products, fabrics, garments, hard surfaces, hair and skin.

When describing the “two orifices” or “two orifice units” of the present invention, we herein mean “at least two orifices” or “at least two orifice units”.

By “shear” we herein mean, a strain produced by pressure in the structure of a substance, when its layers are laterally shifted in relation to each other.

By “turbulence” we herein mean, the irregular and disordered flow of fluids.

By “cavitation” we herein mean, the formation of bubbles in a liquid due to the hydrodynamics of the liquid and the collapsing of those bubbles further downstream.

By “operating pressure” we herein mean the pressure of the liquid(s) in the pre-mix chamber 2.

Unless otherwise noted, all component or composition levels are in reference to the active portion of that component or composition, and are exclusive of impurities, for example, residual solvents or by-products, which may be present in commercially available sources of such components or compositions.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Fabric Care Compositions

In one aspect, the fabric care compositions disclosed herein may be fluid fabric enhancers.

In one aspect, a fluid fabric softener comprising a composition that comprises, based on total fluid fabric softener weight, from about 2% to about 25%, from about 3% to about 15% or even from about 3% to about 7% of one or more cationic fabric softening actives; and from about 2% to about 20%, from about 3% to about 16% or even from about 3% to about 10% of one or more fatty amphiphiles comprising one or more C₁₀-C₂₂ moieties, C₁₆-C₂₀ moieties, or C₁₆-C₁₈ moieties; said composition having at least one melt transition temperature, two melt transition temperatures or even three melt transition temperatures that are at least 3° C., from 3° C. to about 20° C., from about 5° C. to about 15° C., or even from about 5° C. to about 12° C. higher than the melt transition temperature of individual dispersions of any cationic fabric softening active or amphiphile that is employed in said fluid fabric softener is disclosed.

In one aspect of said fluid fabric softener, said cationic fabric softener active may be selected from the group consisting of: linear quaternary ammonium compounds, branched quaternary ammonium compounds, cyclic quaternary ammonium compounds and mixtures thereof; said quaternary ammonium compounds comprising:
one or more C₁₀-C₂₂ fatty acid moieties, C₁₆-C₂₀ fatty acid moieties, or C₁₆-C₁₈ fatty acid moieties, said fatty acid moieties having an Iodine value from 0 to about 95, 0 to about 60, or 15 to about 55;
a counter ion, in one aspect, said counter ion is selected from the group consisting of chloride, bromide, methylsulfate, ethylsulfate, sulfate, and nitrate, in one aspect, said counter ion is selected from the group consisting of chloride, methyl sulphate; and
one or more moieties selected from the group consisting of alkyl moieties, ester moieties, amide moieties, and ether moieties said one or more moieties being covalently bound to the nitrogen of said quaternary ammonium compound.

In one aspect of said fluid fabric softener, said cationic fabric softening active may be selected from the group consisting of: an ester quaternary ammonium compound, in one aspect, said ester quaternary ammonium compound is selected from the group consisting of N,N-bis(stearoyl-oxy-ethyl)N,N-dimethyl ammonium chloride, N,N-bis(tallowoyl-oxy-ethyl)N,N-dimethyl ammonium chloride, N,N-bis(stearoyl-oxy-ethyl)N-(2 hydroxyethyl)N-methyl ammonium methyl sulfate, N,N-bis(stearoyl-oxy-ethyl)N,N-diisopropyl ammonium methylsulfate, N,N-bis(tallowoyl-oxy-ethyl)N,N-diisopropyl ammonium methylsulfate, and mixtures thereof; an alkylated quaternary ammonium compound, in one aspect, said alkylated quaternary ammonium compound is selected from the group consisting of dicanoladimethylammonium chloride, di(hard)tallowedimethylammonium chloride, distearyldimethylammonium chloride, dicanoladimethylammonium methylsulfate, dioleyldimethylammonium chloride and mixtures thereof; an alkoxylated quaternary ammonium compound, in one aspect, said alkoxylated quaternary ammonium compound is selected from the group consisting of ethoxylated coco alkylbis(hydroxyethyl)methyl quaternary ammonium chloride, alkyl polyglycol ether ammonium methylchloride and mixtures thereof; and mixtures thereof.

In one aspect of said fluid fabric softener, said amphiphile may comprises one or more moieties selected from the group consisting of an alcohol moiety, an ester moiety, an amide moiety and mixtures thereof.

In one aspect of said fluid fabric softener, said amphiphile may be selected from the group consisting of: a fatty alcohol, in one aspect said fatty alcohol may be selected from the group comprising lauryl alcohol, cetyl alcohol, stearyl alcohol, behenyl alcohol and mixtures thereof; an alkoxylated fatty alcohol, in one aspect said alkoxylated fatty alcohol may be selected from the group consisting of polyoxyethylene lauryl ether, polyoxyethylene cetyl ether, polyoxyethylene stearyl ether, polyoxyethylene behenyl ether and mixtures thereof, in one aspect, said alkoxylated fatty alcohol's polyoxyethylene moiety comprises from about 2 to about 150, from about 5 to about 100, or from about 10 to about 50 ethylene oxide moieties; a fatty ester, in one aspect, said fatty esters may be selected from the group consisting of:
(i) a glyceride, in one aspect, said glycerides may be selected from the group consisting of monoglycerides, diglycerides, triglycerides and mixtures thereof. In one aspect, said glycerides may comprise fatty acid ester moieties comprising carbon chains having a carbon chain length of from about 10 to about 22 carbon atoms
(ii) a sorbitan ester, in one aspect, said sorbitan ester may be selected from the group consisting of polyoxyethylene sorbitan monostearate, polyoxyethylene sorbitan monooleate, polyoxyethylene sorbitan monopalmitate, polyoxyethylene sorbitan monolaurate and mixtures thereof, in one aspect, said sorbitan ester's polyoxyethylene moiety may comprise from 2 to about 150, from about 5 to about 100, or from about 10 to about 50 ethylene oxide moieties;
   a poly(glycerol ester), in one aspect, said poly(glycerol ester) may be selected from the group consisting poly(glycerol esters) having the following formula

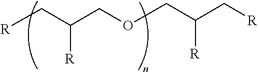

wherein each R is independently selected from the group consisting of fatty acid ester moieties comprising carbon chains, said carbon chains having a carbon chain length of from about 10 to about 22 carbon atoms; —OH; and combinations thereof;
wherein n is from 1.5 to about 10 with the provisos that: when n is from about 1.5 to about 6, the average % esterification of said polyglycerol ester is from about 20% to about 100%; when n is from about 1.5 to about 5, the average % esterification is from about 20% to about 90%; when n is from about 1.5 to about 4, the average % esterification is from about 20% to about 80%; and more than about 50% of said polyglycerol ester in said composition has at least two ester linkages and mixtures thereof; and mixtures of said fatty alcohol, alkoxylated fatty alcohol, fatty ester and poly(glycerol ester)s.

In one aspect of said fluid fabric softener, said fluid fabric softener may comprise, based on total composition weight, from about 0% to about 0.75%, from about 0% to about 0.5%, from about 0.01% to about 0.2%, from about 0.02% to about 0.1% or even from about 0.03% to about 0.075% of a salt. In one aspect of said fluid fabric softener, said salt may be selected from the group consisting of sodium chloride, potassium chloride, calcium chloride, magnesium chloride and mixtures thereof.

In one aspect of said fluid fabric softener, said fluid fabric softener may comprise, from about from about 0.01% to about 20%, from about 0.1% to about 15%, or from about 0.15% to about 10%, based on total weight of the composition, of a cationic polymer. In one aspect of said fluid fabric softener, said cationic polymer may be selected from the group consisting of polyethyleneimine, alkoxylated polyethleneimine; alkyl polyethyleneimine and quaternized polyethyleneimine, poly(vinylamine), poly(vinylformamide)-co-poly(vinylamine), poly(vinylamine)-co-poly(vinyl alcohol) poly(diallyldimethylammonium chloride), poly(acrylamide-co-diallyldimethylammonium chloride), poly(acrylamide-methacrylamidopropyltrimethyl ammonium chloride), poly(acrylamide-co-N,N-dimethyl aminoethyl acrylate), poly(acrylamide-co-N,N,N-trimethyl aminoethyl acrylate), poly(N,N-dimethyl aminoethyl acrylate), poly(N,N,N-trimethyl aminoethyl acrylate), poly(N,N-dimethyl aminoethyl methacrylate), poly(N,N,N-trimethyl aminoethyl methacrylate), poly(acrylamide-co-N,N-dimethylaminoethyl methacrylate), poly(acrylamide-co-N,N,N-trimethylaminoethyl methacrylate), poly(hydroxyethylacrylate-co-dimethyl aminoethyl methacrylate), poly(hydroxyethylacrylate-co-trimethyl aminoethyl methacrylate), poly(hydroxpropylacrylate-co-methacrylamidopropyltrimethylammonium chloride), poly(acrylamide-co-diallyldimethylammonium chloride-co-acrylic acid), poly(acrylamide-methacrylamidopropyltrimethyl ammonium chloride-co-acrylic acid), poly(vinylpyrrolidone-co-dimethylaminoethyl methacrylate), poly(ethyl methacrylate-co-quaternized dimethylaminoethyl methacrylate), poly(ethyl methacrylate-co-oleyl methacrylate-co-diethylaminoethyl methacrylate), poly(acrylate-co-methacrylamidopropyltrimethylammonium, poly(methacrylate-co-methacrylamidopropyltrimethylammonium, poly(diallyldimethylammonium chloride-co-acrylic acid), poly(vinyl pyrrolidone-co-quaternized vinyl imidazole) and mixtures thereof.

35. The fluid fabric softener of claim 26, said composition comprising a perfume delivery system, in one aspect said perfume delivery system is selected from the group consisting of a perfume microcapsule, a perfume microcapsule comprising a deposition aid coating, a pro-perfume, and/or a silicone softening agent, in one aspect, said silicone softening agent is selected from the group consisting of polydimethylsiloxane, an aminosilicone, an organosiloxane polymer and mixtures thereof.

In one aspect of said fluid fabric softener, said fluid fabric softener may comprise, an adjunct ingredient selected from the group consisting of solvents, chelating agents, dye transfer inhibiting agents, dispersants, polymeric dispersing agents, clay soil removal/anti-redeposition agents, brighteners, suds suppressors, dyes, perfume, benefit agent delivery systems, structure elasticizing agents, carriers, hydrotropes, processing aids and/or pigments, cationic starches, scum dispersants, dye, hueing agent, optical brighteners, antifoam agents, stabilizer, pH control agent, metal ion control agent, odor control agent, preservative, antimicrobial agent, chlorine scavenger, anti-shrinkage agent, fabric crisping agent, spotting agent, anti-oxidant, anti-corrosion agent, bodying agent, drape and form control agent, smoothness agent; static control agent, wrinkle control agent, sanitization agent, disinfecting agent, germ control agent, mold control agent, mildew control agent, antiviral agent, drying agent, stain resistance agent, soil release agent, malodor control agent, fabric refreshing agent, dye fixative, color maintenance agent, color restoration/rejuvenation agent, anti-fading agent, anti-abrasion agent, wear resistance agent, fabric integrity agent, anti-wear agent, and rinse aid, UV protection agent, sun fade inhibitor, insect repellent, anti-allergenic agent, enzyme, flame retardant, water proofing agent, fabric comfort agent, water conditioning agent, shrinkage resistance agent, stretch resistance agent, and mixtures thereof.

### Process of Making Liquid Fabric Care Compositions

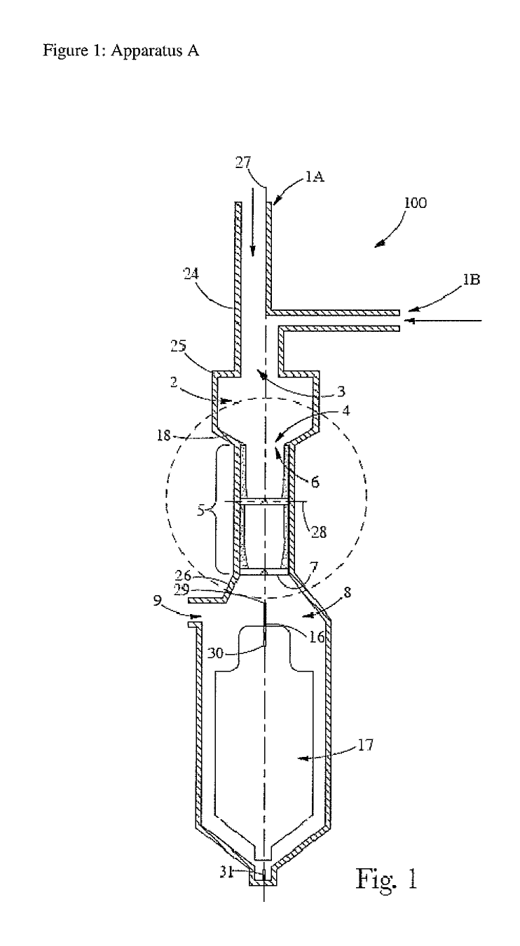

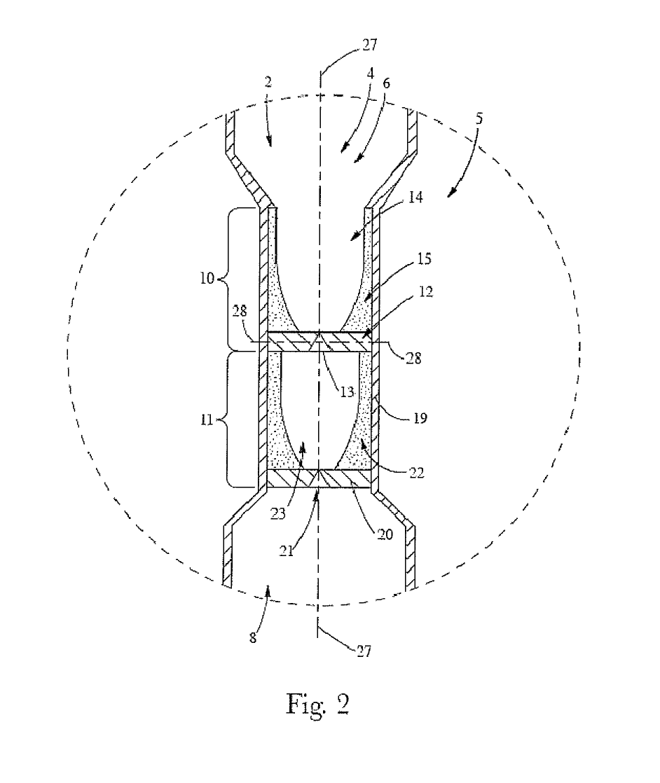

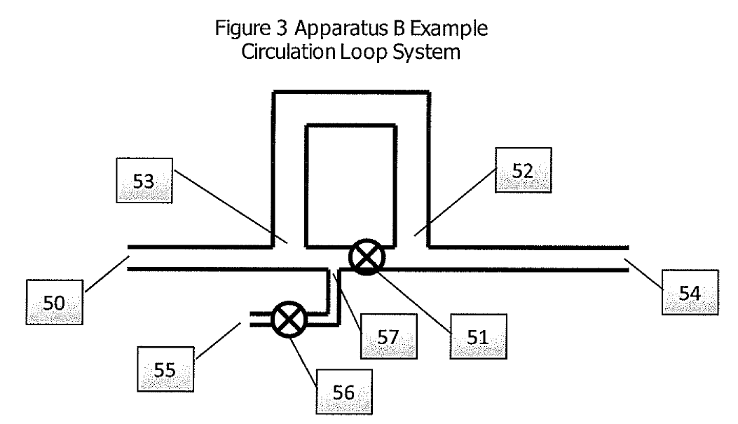

The methods of making fabric care compositions, which comprise polyglycerol esters (PGEs) and a fabric softening active (FSA), described herein generally comprise the steps of: mixing a fabric softener active with a mixture of polyglycerol esters to form a first mixture; combining the first mixture with water and, optionally, a salt to form a second mixture; combining the second mixture with a material selected from a delivery enhancing agent, e.g., cationic polymer, an antifoam agent, a chelant, a preservative, a structurant, a silicone, a phase stabilizing polymer, a perfume, a perfume microcapsule, a dispersant, or a combination thereof to form the liquid fabric care composition. The PGE mixture and the FSA may each be melted prior to mixing, such that a PGE melt and a FSA melt are mixed to form a first mixture (PGE/FSA co-melt). Alternatively, the PGE mixture and the FSA may each be provided as a solid component, e.g., pellets, mixed, and then melted to form a first mixture (PGE/FSA co-melt). Alternatively still, the PGE mixture may be melted to form a PGE melt, the FSA may be melted to form a FSA melt, and the two melts may be simultaneously combined with water. When combining the PGE melt and the FSA melt or the first mixture (PGE/FSA co-melt) with water and, in one aspect salt, the salt can be typically dissolved in the water and the water is at a temperature of about 5° C. to about 100° C., alternatively about 5° C. to about 80° C., alternatively 80° C. to about 100° C., alternatively 70° C. to about 100° C., typically about 100° C. in smaller batch processes, and typically about 75° C. in continuous multi-orifice processes. The salt may be selected from sodium chloride, potassium chloride, calcium chloride and magnesium chloride. Water may then be added to the PGE melt and the FSA melt, simultaneously, to form an aqueous mixture or to the first mixture to form a second mixture. Alternatively, the PGE melt and the FSA melt may be simultaneously added to water to form an aqueous mixture or the first mixture may be added to water to form a second mixture. In a further alternative, the salt may be added separate from the water.
This mixture of PGE, FSA, and salt water is then typically further processed before combining it, with a material selected from a delivery enhancing agent, an antifoam agent, a chelant, a preservative, a structurant, a silicone, a phase stabilizing polymer, a perfume, a perfume microcapsule, a dispersant or a combination thereof to form the liquid fabric care composition. One method of processing the mixture of PGE, FSA, and salt water to form a liquid fabric care composition is milling. For example, a molten organic premix of a fabric softener active, a mixture of polyglycerol esters, and, optionally, other organic materials, except cationic polymer and, in one aspect, not perfume, is prepared and dispersed into a water seat comprising water at about 80-100° C. High shear milling with for example, an IKA Dispax Reactor mill is conducted at a temperature of about 80-100° C., at 2000-6000 rpm, for 30 seconds to 5 minutes. Alternatively, the dispersion may be fed continuously through a dynamic orifice, and/or a series of two or more orifices apparatus A, and/or a second shearing apparatus B and/or a dispersion mill (eg IKA Dispax Reactor) by a pipe (or other such conduit) under feed pressure. The dynamic orifice comprises a valve, wherein the valve can be changed from a fixed first position to a fixed second position all the while feeding the composition through the dynamic orifice. Adjusting the valve (and thus the opening) can quickly and predictably accommodate changes in manufacturing operating conditions. The dynamic orifice and the use thereof are further described in USPA No. 2011/0124548 A1. The dispersion is then cooled to ambient temperature. The composition may be further milled or sheared in Apparatus B after cooling to control viscosity and particle size of the dispersion. As a preferred method, perfume is added at ambient temperature, in one aspect less than about 35° C.
Typically, a material selected from a delivery enhancing agent, e.g., a cationic polymer, an antifoam agent, a chelant, a preservative, a structurant, a silicone, a phase stabilizing polymer, a perfume, a perfume microcapsule, dispersant, or a combination thereof is added to the dispersion after the dispersion has been cooled to ambient temperatures, e.g., less than about 35° C. The cationic polymer in one aspect is added after ingredients such as perfumes, and in one aspect is added before ingredients such as perfumes, and silicones may be added before or after cationic polymers.
Another method of processing the mixture of PGE, FSA, and water to form a liquid fabric care composition is by mixing the components of the composition using cavitation. Cavitation refers to the process of forming vapor bubbles in a liquid. This can be done in a number of manners, such as through the use of a swiftly moving solid body (as an impeller), hydrodynamically, or by high-frequency sound waves. When the bubbles collapse further downstream from the forming location, they release a certain amount of energy, which can be utilized for making chemical or physical transformations.
One particular method for producing hydrodynamic cavitation uses an apparatus known as a liquid whistle. Liquid whistles are described in Chapter 12 “Techniques of Emulsification” of a book entitled Emulsions—Theory and Practice, 3rd Ed., Paul Becher, American Chemical Society and Oxford University Press, NY, N.Y., 2001. An example of a liquid whistle is a SONOLATOR® high pressure homogenizer, which is manufactured by Sonic Corp. of Stratford, Conn., U.S.A.
Processes using liquid whistles have been used for many years. The apparatuses have been used as in-line systems, single or multi-feed, to instantly create fine, uniform and stable emulsions, dispersions, and blends in the chemical, personal care, pharmaceutical, and food and beverage industries. Liquids enter the liquid whistle under very high operating pressures, in some cases up to 1000 bar. By operating pressure, it is understood to mean the pressure of the liquid(s) as it enters the liquid whistle device. This ensures efficient mixing of the liquids within the apparatus. Such operating pressures may be achieved by using, for example, a Sonolator® High Pressure Homogenizer.
Lower operating pressures may be used, while achieving the same degree of mixing, by mixing a liquid composition comprising fabric softening active and PGE with a second liquid composition using an apparatus comprising two or more orifices arranged in series, Apparatus A. More specifically, a liquid fabric softening composition comprising a fabric softening active and a PGE may be made using a process and Apparatus A and B described herein and shown in FIG. 1, FIG. 2, and FIG. 3.

### Process and Apparatus

The present invention is directed to a process for making a fabric enhancing composition using a Apparatus A and optionally, Apparatus B for mixing the liquid fabric enhancing composition components by producing shear, turbulence and/or cavitation. It should be understood that, in certain embodiments, the ability of the process to induce shear may not only be useful for mixing, but may also be useful for dispersion of solid particles in liquids, liquid in liquid dispersions and in breaking up solid particles. In certain embodiments, the ability of the process to induce shear and/or produce cavitation may also be useful for droplet and/or vesicle formation.
In one aspect, the process of making a fluid composition comprises:
combining a plurality of fluids in an Apparatus A, said apparatus comprising: one or more inlets (1A) and one or more inlets (1B), said one or more inlets (1A) and said one or more inlets (1B) being in fluid communication with one or more suitable liquid transporting devices; a pre-mixing chamber (2), the pre-mixing chamber (2) having an upstream end (3) and a downstream end (4), the upstream end (3) of the pre-mixing chamber (2) being in liquid communication with said one or more inlets (1A) and said one or more inlets (1B); an orifice component (5), the orifice component (5) having an upstream end (6) and a downstream end (7), the upstream end of the orifice component (6) being in liquid communication with the downstream end (4) of the pre-mixing chamber (2), wherein the orifice component (5) is configured to spray liquid in a jet and produce shear, turbulence and/or cavitation in the liquid; a secondary mixing chamber (8), the secondary mixing chamber (8) being in liquid communication with the downstream end (7) of the orifice component (5); at least one outlet (9) in liquid communication with the secondary mixing chamber (8) for discharge of liquid following the production of shear, turbulence and/or cavitation in the liquid, with at least one outlet (9) being located at the downstream end of the secondary mixing chamber (8); the orifice component (5) comprising at least two orifice units, (10) and (11) arranged in series to one another and each orifice unit comprises an orifice plate (12) comprising at least one orifice (13), an orifice chamber (14) located upstream from the orifice plate (12) and in liquid communication with the orifice plate (12); and wherein neighboring orifice plates are distinct from each other;
wherein said combining is achieved by applying a force from about 0.1 bar to about 50 bar, from about 0.5 bar to about 10 bar, from about 1 bar to about 5 bar to said plurality of fluids, said force being applied by said transportation devices,
optionally applying a shearing energy of from about 10 g/cm s² to about 1,000,000 g/cm s², from about 50 g/cm s² to about 500,000 g/cm s² from about 100 g/cm s² to about 100,000 g/cm s², for a residence time from about 0.1 seconds to about 10 minutes, from about 1 second to about 1 minute, from about 2 seconds to about 30 seconds to said combined plurality of fluids,
optionally cooling said combined plurality of fluids, before during and/or after said shearing step, to temperatures from about 5° C. to about 45° C., from about 10° C. to about 35° C., from about 15° C. to about 30° C., from about 20° C. to about 25° C.
optionally, adding a electrolyte, in one aspect, a fluid comprising a electrolyte, to said combined plurality of fluids during said combining and/or said shearing step.
optionally, adding in one or more adjunct ingredients to said plurality of fluids and/or combined plurality of fluids.
optionally, recycling said combined plurality of fluids through one or more portions of said process
is disclosed.
In one aspect, the process comprises adding in one or more adjunct ingredients useful for fabric conditioning.
In one aspect of said process, the fabric softening active is present between 50% and 100% by weight of the fabric softening active composition.

### The Apparatus A

FIG. 1 shows one embodiment of an Apparatus A for mixing liquids by producing shear, turbulence and/or cavitation, said apparatus comprising, at least one inlet 1A and a pre-mixing chamber 2. The pre-mixing chamber has an upstream end 3 and a downstream end 4, the upstream end 4 being in liquid communication with the at least one inlet 1A. The Apparatus A also comprises an orifice component 5, the orifice component 5 having an upstream end 6 and a downstream end 7. The upstream end of the orifice component 6 is in liquid communication with the downstream end 4 of the pre-mixing chamber 2, and the orifice component 5 is configured to spray liquid in the form of a jet and produce shear or cavitation in the liquid. A secondary mixing chamber 8 is in liquid communication with the downstream end 7 of the orifice component 5. At least one outlet 9 communicates with the secondary mixing chamber 8 for discharge of liquid following the production of shear, turbulence or cavitation in the liquid, and is located at the downstream end of the secondary mixing chamber 8.
A liquid(s) can be introduced into the inlet 1A at a desired operating pressure. The liquid can be introduced at a desired operating pressure using standard liquid pumping devices. The liquid flows from the inlet into the pre-mix chamber 2 and then into the orifice component 5. The liquid will then exit the orifice component 5 into the secondary mixing chamber 8, before exiting the Apparatus A through the outlet 9.
As can be seen in FIG. 2, the orifice component comprises at least two orifice units 10 and 11 arranged in series to one another. Each orifice unit comprises an orifice plate 12 comprising at least one orifice 13, an orifice chamber 14 located upstream from the orifice plate and in liquid communication with the orifice plate. In one embodiment, the orifice unit 10 further comprises an orifice bracket 15 located adjacent to and upstream from the orifice plate 12, the walls of the orifice bracket 15 defining a passageway through the orifice chamber 14.
In another embodiment, the Apparatus A comprises at least 5 orifice units arranged in series. In yet another embodiment, the Apparatus A comprises at least 10 orifice units arranged in series.
The Apparatus A may, but need not, further comprise at least one blade 16, such as a knife-like blade, disposed in the secondary mixing chamber 8 opposite the orifice component 5.
The components of the present Apparatus A can include an injector component, an inlet housing 24, a pre-mixing chamber housing 25, an orifice component housing 19, the orifice component 5, a secondary mixing chamber housing 26, a blade holder 17, and an adjustment component 31 for adjusting the distance between the tip of blade 16 and the discharge of the orifice component 5. It may also be desirable for there to be a throttling valve (which may be external to the Apparatus A) that is located downstream of the secondary mixing chamber 8 to vary the pressure in the secondary mixing chamber 8. The inlet housing 24, pre-mixing chamber housing 25, and secondary mixing chamber housing 26 can be in any suitable configurations. Suitable configurations include, but are not limited to cylindrical, configurations that have elliptical, or other suitable shaped cross-sections. The configurations of each of these components need not be the same. In one embodiment, these components generally comprise cylindrical elements that have substantially cylindrical inner surfaces and generally cylindrical outer surfaces.
These components can be made of any suitable material(s), including but not limited to stainless steel, AL6XN, Hastalloy, and titanium. It may be desirable that at least portions of the blade 16 and orifice component 5 to be made of materials with higher surface hardness or higher hardnesses. The components of the Apparatus A can be made in any suitable manner, including but not limited to, by machining the same out of solid blocks of the materials described above. The components may be joined or held together in any suitable manner.
The various elements of the Apparatus A has described herein, are joined together. The term “joined”, as used in this specification, encompasses configurations in which an element is directly secured to another element by affixing the element directly to the other element; configurations in which the element is indirectly secured to the other element by affixing the element to intermediate member(s) which in turn are affixed to the other element; configurations where one element is held by another element; and configurations in which one element is integral with another element, i.e., one element is essentially part of the other element. In certain embodiments, it may be desirable for at least some of the components described herein to be provided with threaded, clamped, or pressed connections for joining the same together. One or more of the components described herein can, for example, be clamped, held together by pins, or configured to fit within another component.
The Apparatus A comprises at least one inlet 1A, and typically comprises two or more inlets, such as inlets 1A and 1B, so that more than one material can be fed into the Apparatus A. The Apparatus A can comprise any suitable number of inlets so that any of such numbers of different materials can be fed into the Apparatus A. In another embodiment, a pre-mix of two liquids can be introduced into just one inlet of the Apparatus A. This pre-mix is then subjected to shear, turbulence and/or cavitation as it is fed through the Apparatus A.
The Apparatus A may also comprise at least one drain, or at least one dual purpose, bidirectional flow conduit that serves as both an inlet and drain. The inlets and any drains may be disposed in any suitable orientation relative to the remainder of the Apparatus A. The inlets and any drains may, for example, be axially, radially, or tangentially oriented relative to the remainder of the Apparatus A. They may form any suitable angle relative the longitudinal axis of the Apparatus A. The inlets and any drains may be disposed on the sides of the apparatus. If the inlets and drains are disposed on the sides of the apparatus, they can be in any suitable orientation relative to the remainder of the apparatus.
In one embodiment the Apparatus A comprises one inlet 1A in the form of an injector component that is axially oriented relative to the remainder of the apparatus. The injector component comprises an inlet for a first material.
The pre-mixing chamber 2 has an upstream end 3, a downstream end 4, and interior walls. In certain embodiments, it may further be desirable for at least a portion of the pre-mixing chamber 2 to be provided with an initial axially symmetrical constriction zone 18 that is tapered (prior to the location of the downstream end of the injector) so that the size (e.g. diameter) of the upstream mixing chamber 2 becomes smaller toward the downstream end 4 of the pre-mixing chamber 2 as the orifice component 5 is approached.
   The orifice component 5 can be in any suitable configuration. In some embodiments, the orifice component 5 can comprise a single component. In other embodiments, the orifice component 5 can comprise one or more components of an orifice component system. One embodiment of an orifice component system 5 is shown in greater detail in FIG. 2.
   The apparatus comprises an orifice component 5, wherein the orifice component comprises at least a first orifice unit 10 and a second orifice unit 11.
   In the embodiment shown in FIG. 2 the orifice component 5 comprises an orifice component housing 19. The first orifice unit 10 comprises a first orifice plate 12 comprising a first orifice 13 and a first orifice chamber 14. In one embodiment, the first orifice unit 10 further comprises a first orifice bracket 15. The second orifice unit 11 also comprises a second orifice plate 20 comprising a second orifice 21, a second orifice chamber 23 and optionally a second orifice bracket 22. Looking at these components in greater detail, the orifice component housing 19 is a generally cylindrically-shaped component having side walls and an open upstream end 6, and a substantially closed (with the exception of the opening for the second orifice 21) downstream end 7.
   Looking now at the first orifice unit 10, the orifice chamber 14 is located upstream from, and in liquid communication with, the orifice plate 12. The first orifice bracket 15 is sized and configured to fit inside the orifice component housing 9 adjacent to, and upstream of, the first orifice plate 12 to hold the first orifice plate 12 in place within the orifice component housing 9. The first orifice bracket 15 has interior walls which define a passageway through the first orifice chamber 14.
   The second orifice unit 11 is substantially the same construction as the first orifice unit 10. The orifice units 10 and 11 are arranged in series within the orifice component 5. Any number of orifice units can be arranged in series within the orifice component 5. Each orifice plate can comprise at least one orifice. The orifices can be arranged anywhere upon the orifice plate, providing they allow the flow of liquids through the Apparatus A. Each orifice plate can comprise at least one orifice arranged in a different orientation than the next orifice plate. In one embodiment, each orifice plate comprises at least one orifice that is arranged so that it is off-centered as compared to the orifice in the neighbouring orifice plate. In one embodiment, the size of the orifice within the orifice plate can be adjusted in situ to make it bigger or smaller, i.e. without changing or removing the orifice plate.
   The first orifice bracket 15 and second orifice bracket 22, can be of any suitable shape or size, providing they secure the first orifice plates during operation of the Apparatus A. FIGS. 1 and 2 show an example of the orientation and size of an orifice bracket 22. In another embodiment, the orifice bracket 22 may extend only half the distance between the second orifice plate 20 and the first orifice plate 12. In yet another embodiment, the second orifice bracket 22 may extend only a quarter of the distance between the second orifice plate 20 and the first orifice plate 12.
   In one embodiment, the orifice plate 12 is hinged so that it can be turned 90° about its central axis. The central axis can be any central axis, providing it is perpendicular to the centre-line 27, which runs along the length of the Apparatus A. In one embodiment, the central-axis can be along the axis line 28. By allowing the orifice 12 to be moved 90° about its central axis, build up of excess material in the first orifice chamber 14 and/or second orifice chamber 23 can be more readily removed. In one embodiment, the size and/or orientation of the first orifice bracket 15 can be adjusted to allow the rotation of the first orifice plate 12. For example, in one embodiment, the first orifice bracket 15 can be unsecured and moved in an upstream direction away from the first orifice plate 12 towards the pre-mixing chamber 2. The orifice plate 12 can then be unsecured and rotated through 90°. Once the Apparatus A is clean, the first orifice plate 12 can be returned to its original operating configuration and then if present, the first orifice bracket 15 returned to its original operating position. The second orifice plate 20 and also any extra orifice plates present, may also be hinged. The second orifice bracket 22 and any other orifice brackets present may also be adjustable in the manner as described for the first orifice bracket 15.
   Any two orifice plates must be distinct from one another. In other words neighbouring orifice plates must not be touching. By “neighbouring”, we herein mean the next orifice plate in series. If two neighbouring plates are touching, mixing of liquids between orifices is not achievable. In one embodiment, the distance between the first orifice plate 12 and the second orifice plate 20 is equal to or greater than 1 mm.
   The elements of the orifice component 5 form a channel defined by walls having a substantially continuous inner surface. As a result, the orifice component 5 has few, if any, crevices between elements and may be easier to clean than prior devices. Any joints between adjacent elements can be highly machined by mechanical seam techniques, such as electro polishing or lapping such that liquids cannot enter the seams between such elements even under high pressures.
   The orifice component 5, and the components thereof, can be made of any suitable material or materials. Suitable materials include, but are not limited to stainless steel, tool steel, titanium, cemented tungsten carbide, diamond (e.g., bulk diamond) (natural and synthetic), and coatings of any of the above materials, including but not limited to diamond-coated materials.
   The orifice component 5, and the elements thereof, can be formed in any suitable manner. Any of the elements of the orifice component 5 can be formed from solid pieces of the materials described above which are available in bulk form. The elements may also be formed of a solid piece of one of the materials specified above, which may or may not be coated over at least a portion of its surface with one or more different materials specified above. Since the Apparatus A requires lower operating pressures than other shear, turbulence and/or cavitation devices, it is less prone to erosion of its internal elements due to mechanical and/or chemical wear at high pressures. This means that it may not require expensive coating, such as diamond-coating, of its internal elements.
   In other embodiments, the orifice component 5 with the first orifice 13 and the second orifice 21 therein can comprise a single component having any suitable configuration, such as the configuration of the orifice component shown in FIG. 2. Such a single component could be made of any suitable material including, but not limited to, stainless steel. In other embodiments, two or more of the elements of the orifice component 5 described above could be formed as a single component.
   The first orifice 13 and second orifice 21 are configured, either alone, or in combination with some other component, to mix the fluids and/or produce shear, turbulence and/or cavitation in the fluid(s), or the mixture of the fluids. The first orifice 13 and second orifice 21 can each be of any suitable configuration. Suitable configurations include, but are not limited to slot-shaped, eye-shaped, cat eye-shaped, elliptically-shaped, triangular, square, rectangular, in the shape of any other polygon, or circular.
   The blade 16 has a front portion comprising a leading edge 29, and a rear portion comprising a trailing edge 30. The blade 16 also has an upper surface, a lower surface, and a thickness, measured between the upper and lower surfaces. In addition, the blade 16 has a pair of side edges and a width, measured between the side edges.
   As shown in FIG. 1, when the blade 16 is inserted into the Apparatus A, a portion of the rear portion of the blade 16 is clamped, or otherwise joined inside the apparatus so that its position is fixed. The blade 16 can be configured in any suitable manner so that it can be joined to the inside of the apparatus.
   As shown in FIG. 1, in some embodiments, the apparatus 16 may comprise a blade holder 17.
   The Apparatus A comprises at least one outlet or discharge port 9.
   The Apparatus A may comprise one or more extra inlets. These extra inlets can be positioned anywhere on the Apparatus A and may allow for the addition of extra liquids. In one embodiment, the second orifice unit comprises an extra inlet. In another embodiment, the secondary mixing chamber comprises an extra inlet. This allows for the addition of an extra liquid to be added to liquids that have exited the orifice component 5.
   It is also desirable that the interior of the Apparatus A be substantially free of any crevices, nooks, and crannies so that the Apparatus A will be more easily cleanable between uses. In one embodiment of the Apparatus A described herein, the orifice component 5 comprises several elements that are formed into an integral structure. This integral orifice component 5 structure fits as a unit into the pre-mixing chamber housing and requires no backing block to retain the same in place, eliminating such crevices.
   Numerous other embodiments of the Apparatus A and components therefore are possible as well. The blade holder 17 could be configured to hold more than one blade 16. For example, the blade holder 17 could be configured to hold two or more blades.

### Apparatus B

Applicants have found it is desirable to subject said fluid from said outlet 9 of Apparatus A, to additional shear and/or turbulence for a period of time within Apparatus B to transform said liquid into a desired microstructure. Shear or turbulence imparted to said fluid may be quantified by estimating the total kinetic energy per unit fluid volume. The total kinetic energy imparted to the fluid is the sum total of the kinetic energy per unit fluid volume times the residence time as said fluid flows through each of the conduits, pumps, and in-line shearing or turbulence devices that the fluid experiences.)
In one aspect, Apparatus B may comprise one or more inlets for the addition of adjunct ingredients.
In one embodiment of Apparatus B, one or more Circulation Loop Systems are in fluid communication to said outlet 9 of Apparatus A. Said Circulation Loop systems may be arranged in series or in parallel. Said fluid from outlet 9 of Apparatus A is fed to one or more Circulation Loop Systems, composed of one or more fluid inlets, connected to one or more circulation system pumps, one or more circulation loop conduits of a specified cross sectional areas and lengths, one or more connections from said circulating loop conduits to said inlet of one or more circulation pumps, and one or more fluid outlets, connected to said circulation loop system conduits. It is recognized that one or more conduits may be necessary to achieve the desired residence time. One or more bends or elbows in said conduits may be useful to minimize floor space.
An example of said Circulation Loop Systems is shown if FIG. 3. Said fluid from Apparatus A outlet 9 is fed to a single Circulation Loop System comprising a fluid inlet, 50, in fluid communication with a circulation loop system pump, 51, in fluid communication with a circulation system loop conduit of a specified cross sectional area and length, 52, in fluid communication with a fluid connection, 53, from said circulating loop conduit 52 to said inlet of said circulation pump 51, and a fluid outlet, 54, in fluid communication with said circulation loop conduit, 52. In said embodiment, said fluid inlet flow rate is equal to the fluid outlet flow rate. Said Circulation Loop System has a Circulation Loop Flow Rate equal to or greater than said inlet or outlet flow rate into or out of said Circulation Loop System. The Circulating Loop System may be characterized by a Circulation Flow Rate Ratio equal to the Circulation Flow Rate divided by the Inlet or Outlet Flow Rate.

Said Circulation Loop System example has one or more conduit lengths and diameters and pumps arranged in a manner that imparts shear or turbulence to the fluid. The circulation loop conduits may be in fluid communication with one or more devices to impart shear or turbulence to said fluid including but not limited to static mixers, orifices, flow restricting valves, and/or in-line motor driven milling devices as those supplied by IKA, Staufen and devices known in the art. It is recognized that one or more bends or elbows in said conduits may be useful to deliver the desired kinetic energy and residence time while minimizing floor space. The duration of time said fluid spends in said Circulation Loop System example may be quantified by a Residence Time equal to the total volume of said Circulation Loop System divided by said fluid inlet or outlet flow rate.

In another embodiment, Apparatus B may be comprised of one or more continuously operated tanks arranged either in series or in parallel. The fluid from Apparatus A outlet 9 is in fluid communication and continuously fed to an tank of suitable volume and geometry. In a example, said fluid enters and leaves said tank at identical flow rates. The residence time of said fluid in said tanks is equal to the volume of fluid in said tanks divided by the inlet or outlet flow rates. Said tanks may be fitted with one or more agitation devices such as mixers consisting of one or more impellers attached to one or more shafts that are driven by one or more motors. The agitation device maybe also be one or more tank milling devices such as those supplied by IKA, Staufen, Germany, including batch jet mixers and rotor-stator mills. The tank may be fitted with one or more baffles to enhance mixing shear or turbulence within the tank. The tank may consist of a means to control the fluid temperature within the tank using but not limited to internal coils or a wall jacket containing a circulating cooling or heating fluid.
The tank may also have an external circulation system that provides additional kinetic energy per unit fluid volume and residence time. Said external circulating system may consist but is not limited to one or more tank outlet conduits, one or more motor driven fluid pumps, one or more static shearing devices, one or more motor driven shearing mills, one or more inlet circulation conduits returning the fluid back to the tank all in fluid communication and may be arranged in series or parallel.
In another embodiment of Apparatus B, one or more of said tanks may be filled with fluid and held in the tank with mixing and or circulation as described above to impart kinetic energy per unit fluid volume for a desired residence time and then removed from an outlet from the tank.
In another embodiment of Apparatus B, one or more conduits may be used to impart shear or turbulence to a fluid for a desired residence time. The conduit may be in fluid communication with but not limited to one or more motor driven fluid pumps, one or more static shearing devices, one or more motor driven shearing mills, arranged in any order in series or parallel. It is recognized that one or more long conduits may be necessary to achieve the desired residence time. One or move bends or elbows in said conduits may be useful to minimize floor space.
During said shearing and turbulence within Apparatus B, one or more optional adjunct fluids may be added to said fluids to help create the desired fluid microstructure. Addition of said optional adjunct fluids to said fluid may be accomplished by means known to those in the fluid processing industry and added anywhere in Apparatus B. Not bound by theory, one or more optional adjunct fluids may be added at a point in Apparatus B that insures uniform dispersion and mixing of said optional adjunct fluid with said fluid. In one embodiment in the Continuous Loop System example above, said optional adjunct fluids may be introduced at an inlet, 55, by means of a pump, 56, to an injector, 57, in fluid communication with the continuous loop pump, 51, inlet. Additionally, said optional adjunct fluid also may also be added at, but not limited to, said continuous loop inlet, 50, and or in said circulation loop conduit, 52, and or simultaneously in any combination of addition points.
During shearing in Apparatus B, the temperature of said fluid may be controlled or changed depending on the transformation requirements. In one embodiment, it may be useful to alter said fluid temperature within Apparatus B. Said fluid temperature change may be accomplished by means known to those in the fluid processing industry and may include but are not limited to heat exchangers, pipe jackets, and injection of one or more additional hotter or colder optional adjunct fluids into said fluid.
In one aspect, the fluid communication between the outlet of Apparatus A and the inlet of Apparatus B, may be limited to a fluid residence time of less than about 10 minutes, less than about 1 minute, less than about 20 seconds, less than about 10 seconds, less than about 5 seconds, or less than about 3 seconds depending on the transformations required. In another aspect, the fluid communication between the outlet of Apparatus A and the inlet of Apparatus B, may be limited to a fluid residence time of from about 0.01 seconds to about 10 minutes.
Said fluid inlets and outlets of said Apparatus B may be in fluid communication with one or more other devices. These devices include but are not limited to a means of regulating the temperature of said fluid including but not limited to heat exchangers, means of regulating Apparatus B pressure including but not limited to pressure control valves and booster pumps, means of removing contaminants from said fluid including but not limited to filtration devices, means of adding one or more adjunct ingredients to said fluid from but not limited to adjunct ingredient delivery systems, means of monitoring process control features including but not limited to flow, pressure and temperature gauges and transmitters, sampling valves and means of cleaning and sanitization.
Applicants believe, although not bound by theory, that Apparatus B should be designed to impart a uniformly consistent kinetic energy over a period of time to each fluid volume element to ensure uniformity of the desired fluid microstructure attributes.
The liquid fabric softening active/fatty amphiphile composition comprises a fabric softening active, as described below, fatty amphiphile (eg. a polyglycerol ester mixture), as described below, and, optionally, a solvent. The fatty amphiphile is thereby added to the FSA before the FSA is hydrated, e.g., mixed with the second liquid composition. The liquid fabric softening active/fatty amphiphile composition is introduced into the Apparatus A through the first inlet 1A. In certain embodiments, the fabric softening active is present at a concentration between 15% and 95% by weight of the fabric softening active/fatty amphiphile composition, preferably between 20% and 60% by weight of the fabric softening active/fatty amphiphile composition, more preferably between 30% and 55% by weight of the fabric softening active/composition. In certain embodiments, the fatty amphiphile is present at a concentration between about 15% and 95% by weight of the fabric softening active/fatty amphiphile composition, preferably between 20% and 60% by weight of the fabric softening active/PGE composition, more preferably between 30% and 55% by weight of the fabric softening active/composition. In some embodiments, the solvent is selected from ethanol or isopropanol. The solvent may optionally contain a diluent such as propylene glycol, ethylene glycol, glycerol, naturally derived oils, e.g., tallow fat, coconut oil. In some embodiments, there is no solvent or diluent. In some embodiments, the liquid fabric softening active/fatty amphiphile composition is added in a molten form. The liquid fabric softening active/fatty amphiphile composition is preferably heated to a temperature between 70° C. and 90° C. in order to make it molten.
The second liquid composition comprises water (hence, it hydrates the liquid fabric softening active/fatty amphiphile composition when the liquid fabric softening active/fatty amphiphile and the second liquid composition pass through the Apparatus A at the desired flow rate) and may comprise any of the general types of materials that appear in liquid fabric softening compositions known in the art. For example, the second liquid composition may comprise salt, e.g., NaCl, KCl, CaCl₂, silicone compounds, perfumes, encapsulated perfumes, dispersing agents, stabilizers, pH control agents, colorants, brighteners, dyes, odor control agent, pro-perfumes, cyclodextrin, solvents, soil release polymers, preservatives, antimicrobial agents, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mold control agents, mildew control agents, antiviral agents, anti-microbials, drying agents, stain resistance agents, soil release agents, malodor control agents, fabric refreshing agents, chlorine bleach odor control agents, dye fixatives, dye transfer inhibitors, color maintenance agents, color restoration/rejuvenation agents, anti-fading agents, whiteness enhancers, anti-abrasion agents, wear resistance agents, fabric integrity agents, anti-wear agents, defoamers and anti-foaming agents, rinse aids, UV protection agents, sun fade inhibitors, insect repellents, pro-biotics, pre-biotics, anti-allergenic agents, enzymes, flame retardants, water proofing agents, fabric comfort agents, water conditioning agents, shrinkage resistance agents, stretch resistance agents, structurants, chelants, electrolytes, or mixtures thereof. In one embodiment, the second liquid composition comprises silicone compounds. The second liquid composition may also be heated or unheated. In one embodiment, the temperature of the second liquid composition is between 40° C. and 70° C. The pH of the second liquid composition should be adjusted such that the final resultant liquid fabric softening composition has the desired pH. The pH may be adjusted using a mineral acid such as hydrochloric acid or formic acid. The second liquid composition is introduced into the Apparatus A through the second inlet 1B.
The process described above is further discussed in USPA 2011/0172137 A1.

### Fabric Softener Active

According to the present invention, a method of making a fabric care composition, which comprises a fabric softening active and polyglycerol esters, is provided. Liquid fabric care compositions, e.g., fabric softening compositions (such as those contained in DOWNY or LENOR), comprise a fabric softening active. One class of fabric softener actives includes cationic surfactants. Liquid fabric softeners may be described as a concentrated polydispersion of particles made of cationic surfactant. The particles are spherical vesicles of cationic surfactant. The vesicles may act as carriers for perfumes. Imperfections in processing conditions and in softener active compositions can result in incomplete and/or undesirable vesicle formation, e.g., larger than desired vesicles or lamellar sheets. It is believed that these undesirable structures may contribute to high initial rheology, rheology growth with age (thickening upon storage so the fabric softener is no longer pourable), and/or physical instabilities. Without being bound by theory, it is believed that the addition of PGE to the cationic surfactant, before the cationic surfactant is hydrated, results in formation of a gel network microstructure of the cationic surfactant and the PGE that leads to ordered structures with high yield stresses and shear thinning properties (e.g., pourable). A composition prepared by this method comprises a dispersed gel network phase comprising a cationic surfactant and a polyglycerol ester.
The term “gel network” refers to a lamellar or vesicular semi-crystalline phase that comprises at least one surfactant and at least one fatty amphiphile and solvent. The lamellar or vesicular phase comprises bi-layers made up of a first layer comprised of cationic surfactant and a fatty amphiphile, such as PGE, alternating with a second layer comprising the solvent (eg water). For the lamellar crystalline phase to form, the co-actives must be dispersed in solvent. Solid crystalline refers to the structure of the lamellar or vesicular phase which forms at a temperature below the chain melt transition temperature of the cationic surfactant and PGE. The chain melt transition temperature may be measured by Differential Scanning calorimetry (DSC).
The gel network structures the fabric softening composition by providing the desired rheology or viscosity, and thickening the composition. As a result, the composition is physically stable at zero-shear and has shear thinning properties that enable the composition to be dispensed by pouring from a bottle or cap or dispensing in a washing machine. This structuring of the composition by inducing a semi-crystalline lamellar phase (e.g., gel network) may be accomplished without the use of a polymeric structuring agent, thereby simplifying the formulation. Polymer structuring agents may, however, be used in addition to the gel network. Gel Networks are further described by G. M. Ecceleston, “Functions of Mixed Emulsifiers and Emulsifying Waxes in Dermatological Lotions and Creams”, Colloids and Surfaces A: Physiochem and Eng Aspects 123-124 (1997) 169-82.
Examples of cationic surfactants include quaternary ammonium compounds. Exemplary quaternary ammonium compounds include alkylated quaternary ammonium compounds, ring or cyclic quaternary ammonium compounds, aromatic quaternary ammonium compounds, diquaternary ammonium compounds, alkoxylated quaternary ammonium compounds, amidoamine quaternary ammonium compounds, ester quaternary ammonium compounds, and mixtures thereof. A final fabric softening composition (suitable for retail sale) will comprise from about 1.5% to about 50%, alternatively from about 1.5% to about 30%, alternatively from about 2% to about 25%, alternatively from about 3% to about 25%, alternatively from about 3% to about 15%, of cationic fabric softening active by weight of the final composition. Fabric softening compositions, and components thereof, are generally described in US 2004/0204337. In one embodiment, the fabric softening composition is a so called rinse added composition. In such an embodiment, the composition is substantially free of detersive surfactants, alternatively substantially free of anionic surfactants. In another embodiment, the pH of the fabric softening composition is acidic, for example between about pH 2 and about pH 5, alternatively between about pH 2 to about pH 4, alternatively between about pH 2 and about pH 3. The pH may be adjusted with the use of hydrochloric acid or formic acid.
In yet another embodiment, the fabric softening active is DEEDMAC (e.g., ditallowoyl ethanolester dimethyl ammonium chloride). DEEDMAC means mono and di-fatty acid ethanol ester dimethyl ammonium quaternaries, the reaction products of straight chain fatty acids, methyl esters and/or triglycerides (e.g., from animal and/or vegetable fats and oils such as tallow, palm oil and the like) and methyl diethanol amine to form the mono and di-ester compounds followed by quaternization with an alkylating agent.
In one aspect, the fabric softener active is a bis-(2-hydroxyethyl)-dimethylammonium chloride fatty acid ester having an average chain length of the fatty acid moieties of from 16 to 20 carbon atoms, preferably 16 to 18 carbon atoms, and an Iodine Value (IV), calculated for the free fatty acid, from 0 to about 95, 0 to about 60, or 15 to about 55, from 15 to about 25, alternatively from about 18 to about 22, alternatively from about 19 to about 21, alternatively combinations thereof.
The Iodine Value is the amount of iodine in grams consumed by the reaction of the double bonds of 100 g of fatty acid, determined by the method of ISO 3961.
In certain aspects, the fabric softening active comprises a compound of formula (II):

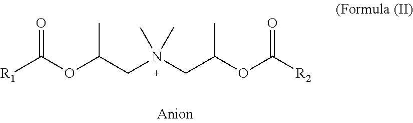

wherein R₁ and R₂ is each independently a C₁₅-C₁₇, and wherein the C₁₅-C₁₇ is unsaturated or saturated, branched or linear, substituted or unsubstituted. This fabric softening active is further described in USPA 2011/0239377 A1
In some aspects, the fabric softening active comprises a bis-(2-hydroxypropyl)-dimethylammonium methylsulphate fatty acid ester having a molar ratio of fatty acid moieties to amine moieties of from 1.85 to 1.99, an average chain length of the fatty acid moieties of from 16 to 18 carbon atoms and an iodine value of the fatty acid moieties, calculated for the free fatty acid, of from 0.5 to 60. This fabric softening active is further described in USPA No. 2011/0239378 A1.
In some aspects, the fabric softening active comprises, as the principal active, compounds of the formula III

### (Formula III)

{R₄₋ₘ—N⁺—[(CH₂)ₙ—Y—R¹]ₘ}A⁻ (Formula III)

wherein each R substituent is either hydrogen, a short chain C₁-C₆, preferably C₁-C₃ alkyl or hydroxyalkyl group, e.g., methyl, ethyl, propyl, hydroxyethyl, and the like, poly (C₂₋₃ alkoxy), preferably polyethoxy, benzyl, or mixtures thereof; each m is 2 or 3; each n is from 1 to about 4, preferably 2; each Y is —O—(O)C—, —C(O)—O—, —NR—C(O)—, or —C(O)—NR—; the sum of carbons in each R¹, plus one when Y is —O—(O)C— or —NR—C(O)—, is C₁₂-C₂₂, preferably C₁₄-C₂₀, with each R¹ being a hydrocarbyl, or substituted hydrocarbyl group, and A⁻ can be any softener-compatible anion, preferably, chloride, bromide, methylsulfate, ethylsulfate, sulfate, and nitrate, more preferably chloride or methyl sulfate;
In some aspects, the fabric softening active has the general formula:

[R₃N⁺CH₂CH(YR¹)(CH₂YR¹)]A⁻

wherein each Y, R, R¹, and A⁻ have the same meanings as before. Such compounds include those having the formula:

[CH₃]₃N⁽⁺⁾[CH₂CH(CH₂O(O)CR¹)O(O)CR¹]Cl⁽⁻⁾ (Formula IV)

wherein each R is a methyl or ethyl group and preferably each R¹ is in the range of C₁₅ to C₁₉. As used herein, when the diester is specified, it can include the monoester that is present.

These types of agents and general methods of making them are disclosed in U.S. Pat. No. 4,137,180, Naik et al., issued Jan. 30, 1979, which is incorporated herein by reference. An example of a preferred DEQA (2) is the “propyl” ester quaternary ammonium fabric softener active having the formula 1,2-di(acyloxy)-3-trimethylammoniopropane chloride.

In some aspects, the fabric softening active has the formula:

[R₄₋ₘ—N⁺—R¹ₘ]A⁻ (Formula V)

wherein each R, R¹, and A⁻ have the same meanings as before.
In some aspects, the fabric softening active has the formula:

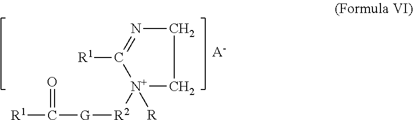

wherein each R, R¹, and A⁻ have the definitions given above; each R² is a C₁₋₆ alkylene group, preferably an ethylene group; and G is an oxygen atom or an —NR— group;
In some aspects, the fabric softening active has the formula:

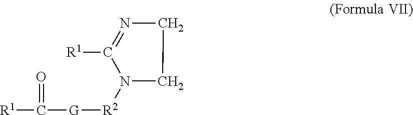

wherein R¹, R² and G are defined as above.
In some aspects, the fabric softening active is a condensation reaction product of fatty acids with dialkylenetriamines in, e.g., a molecular ratio of about 2:1, said reaction products containing compounds of the formula:

R¹—C(O)—NH—R²—NH—R³H—C(O)—R¹ (Formula VIII)

wherein R¹, R² are defined as above, and each R³ is a C₁₋₆ alkylene group, preferably an ethylene group and wherein the reaction products may optionally be quaternized by the additional of an alkylating agent such as dimethyl sulfate. Such quaternized reaction products are described in additional detail in U.S. Pat. No. 5,296,622, issued Mar. 22, 1994 to Uphues et al., which is incorporated herein by reference;
In some aspects, the preferred fabric softening active has the formula:

[R¹—C(O)—NR—R²—N(R)₂—R³—NR—C(O)—R¹]⁺A⁻ (Formula IX)

wherein R, R¹, R², R³ and A⁻ are defined as above;
In some aspects, the fabric softening active is a reaction product of fatty acid with hydroxyalkylalkylenediamines in a molecular ratio of about 2:1, said reaction products containing compounds of the formula:

R¹—C(O)—NH—R²—N(R³OH)—C(O)—R¹ (Formula X)

wherein R¹, R² and R³ are defined as above;
In some aspects, the fabric softening active has the formula:

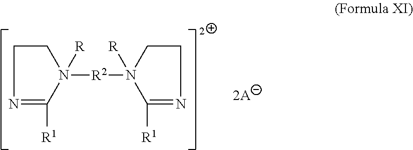

wherein R, R¹, R², and A⁻ are defined as above.
Non-limiting examples of Formula III are N,N-bis(stearoyl-oxy-ethyl)N,N-dimethyl ammonium chloride, N,N-bis(tallowoyl-oxy-ethyl)N,N-dimethyl ammonium chloride, N,N-bis(stearoyl-oxy-ethyl)N-(2 hydroxyethyl)N-methyl ammonium methylsulfate.
Non-limiting examples of Formula IV is 1,2 di(stearoyl-oxy) 3 trimethyl ammoniumpropane chloride.
Non-limiting examples of Formula V are dialkylenedimethylammonium salts such as dicanoladimethylammonium chloride, di(hard)tallowedimethylammonium chloride dicanoladimethylammonium methyl sulfate. An example of commercially available dialkylenedimethylammonium salts usable in the present invention is dioleyldimethylammonium chloride available from the Evonik Corporation under the trade name Adogen® 472 and dihardtallow dimethylammonium chloride available from Akzo Nobel Arquad 2HT75.
A non-limiting example of Formula VI is 1-methyl-1-stearoylamidoethyl-2-stearoylimidazolinium methylsulfate wherein R¹ is an acyclic aliphatic C₁₅-C₁₇ hydrocarbon group, R² is an ethylene group, G is a NH group, R⁵ is a methyl group and A⁻ is a methyl sulfate anion, available commercially from the Witco Corporation under the trade name Varisoft®.
A non-limiting example of Formula VII is 1-tallowylamidoethyl-2-tallowylimidazoline wherein R¹ is an acyclic aliphatic C₁₅-C₁₇ hydrocarbon group, R² is an ethylene group, and G is a NH group.
A non-limiting example of Formula VIII is the reaction products of fatty acids with diethylenetriamine in a molecular ratio of about 2:1, said reaction product mixture containing N,N″-dialkyldiethylenetriamine with the formula:

R¹—C(O)—NH—CH₂CH₂—NH—CH₂CH₂—NH—C(O)—R¹

wherein R¹—C(O) is an alkyl group of a commercially available fatty acid derived from a vegetable or animal source, such as Emersol® 223LL or Emersol® 7021, available from Henkel Corporation, and R² and R³ are divalent ethylene groups.
A non-limiting example of Formula IX is a difatty amidoamine based softener having the formula:

[R¹—C(O)—NH—CH₂CH₂—N(CH₃)(CH₂CH₂OH)—CH₂CH₂—NH—C(O)—R¹]⁺CH₃SO₄⁻

wherein R¹—C(O) is an alkyl group, available commercially from the Witco Corporation e.g. under the trade name Varisoft® 222LT.
An example of Formula X is the reaction products of fatty acids with N-2-hydroxyethylethylenediamine in a molecular ratio of about 2:1, said reaction product mixture containing a compound of the formula:

R¹—C(O)—NH—CH₂CH₂—N(CH₂CH₂OH)—C(O)—R¹

wherein R¹—C(O) is an alkyl group of a commercially available fatty acid derived from a vegetable or animal source, such as Emersol® 223LL or Emersol® 7021, available from Henkel Corporation.
An example of Formula XI is the diquaternary compound having the formula:

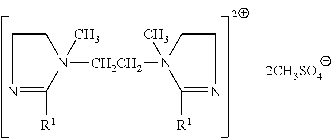

wherein R¹ is derived from fatty acid, and the compound is available from Witco Company.
It will be understood that combinations of softener actives disclosed above are suitable for use in this invention.

Anion A

In the cationic nitrogenous salts herein, the anion A⁻, which is any softener compatible anion, provides electrical neutrality. Most often, the anion used to provide electrical neutrality in these salts is from a strong acid, especially a halide, such as chloride, bromide, or iodide. However, other anions can be used, such as methylsulfate, ethylsulfate, acetate, formate, sulfate, carbonate, and the like. Chloride and methylsulfate are preferred herein as anion A. The anion can also, but less preferably, carry a double charge in which case A⁻ represents half a group.

### Fatty Amphiphile

Suitable fatty amphiphiles include compounds having a hydrophobic tail group and a hydrophilic head group, wherein the compound also has a net neutral charge at the pH of the fabric softening composition. The fatty amphiphile may be characterized as a compound having a Hydrophilic-Lipophilic Balance (“HLB”), as used herein, is the standard HLB according to Griffin, J. Soc. Cosm. Chem., vol. 5, 249 (1954).

Suitable fatty amphiphiles may comprise one or more moieties selected from the group consisting of an alcohol moiety, an ester moiety, an amide moiety and combinations thereof. Examples of such fatty amphiphiles are fatty alcohols, alkoxylated fatty alcohols, glycerol fatty acid esters, sorbitain fatty fatty esters, and poly(glycerol fatty acid esters). Non-limiting examples of the hydrophobic carbon chain include lauryl, tridecyl, myristyl, pentadecyl, cetyl, heptadecyl, stearyl, arachidyl, behenyl, undecylenyl, palmitoleyl, oleyl, palmoleyl, linoleyl, linolenyl, arahchidonyl, elaidyl, elaeostearyl, erucyl, isolauryl, isotridecyl, isomyristal, isopentadecyl, petroselinyl, isocetyl, isoheptadecyl, isostearyl, isoarachidyl, isobehnyl, gadoleyl, brassidyl, and technical-grade mixture thereof.

The hydrophobic carbon chain also may be a branched alkyl group prepared by alkaline condensation of alcohols to give higher molecular weight, branched isoalcohols. These branched isoalcohols are typically referred to in the art as Guerbet alcohols.

The hydrophobic tail group may be alkyl, alkenyl or branched carbon chains of vegetable origin, such as wheat germ, sunflower, grape seed, sesame, maize, apricot, castor, avocado, olive, soybean, sweet almond, palm, rapeseed, cotton seed, hazelnut, macadamia, karite, jojoba, alfalfa, poppy, pumpkinseed, sesame, cucumber, blackcurrant, evening primrose, millet, barley, quinoa, rye, safflower, candlenut, passion flower or musk rose oil, and karite butter.

To form the gel network component of the present invention, individual fatty amphiphile compounds or combinations of two or more different fatty amphiphile compounds may be selected.

### Polyglycerol Ester (PGE)

According to the present invention, a method of making a fabric care composition, which comprises a fabric softening active and a fatty amphiphile, for example polyglycerol esters, is provided. Polyglycerol esters (“PGEs”) are known. See, for example, U.S. Pat. No. 4,214,038 and US 2006/0276370. PGEs are esters typically obtained by reacting polyglycerol and a fatty acid. Polyglycerol esters may be prepared from glycerin as described in the literature, for example, as described in U.S. Pat. No. 6,620,904. In general, oligomerization of the glycerol unit is an intermolecular reaction between two glycerin molecules to form a diglycerol. Two such oligomers can also be reacted together, or an oligomer can be reacted with an additional glycerin to form yet higher oligomers. Polyglycerols may be converted to polyglycerol esters by typical esterification techniques for example, via reaction with fatty acids, fatty acid chlorides, and the like. The fatty acids used in the esterification can be a mixture of fatty acid chain lengths such as, for example, the fatty acid mixtures derived from coconut oil or tallow. The fatty acids may be saturated or unsaturated, and may contain from about 12 to about 22 carbon atoms, or about 10 to 22 carbon atoms. The fatty acid mixtures derived from natural fats and oils such as, for example, rapeseed oil, peanut oil, lard, tallow, coconut oil, palm oil, soybean oil can be converted to saturated form by hydrogenation, such processes being readily understood by one of ordinary skill in the art.
The PGE described herein generally comprises a mixture of polyglycerol esters, wherein each polyglycerol ester in the mixture of polyglycerol esters has the structure of Formula I:

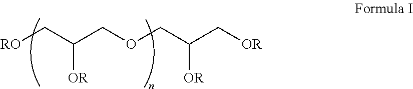

wherein each R is independently selected from the group consisting of fatty acid ester moieties comprising carbon chains having a carbon chain length of from about 10 to about 22 carbon atoms; OH; and combinations thereof;
wherein the mixture of polyglycerol esters has an average value of n ranging from about 1.5 to about 6;
wherein the mixture of polyglycerol esters has an average % esterification ranging from about 20% to about 100%;
wherein greater than or equal to about 50% of the polyglycerol esters in the mixture of polyglycerol esters have at least two ester linkages.
In one aspect, the PGE may be saturated (having an iodine value of about 0 to about 20) or unsaturated (having an iodine value of about 45 to about 135), or may comprise combinations thereof. For example, in one aspect, the PGEs of the compositions have an IV range of from about 40 to about 140; alternatively from about 35 to about 65, alternatively from about 40 to about 60; alternatively from about 1 to about 60, alternatively from about 15 to about 30, alternatively from about 15 to about 25. Further, while it may be acceptable to use cationic fabric softening active compounds with a melt transition temperature from about −50° C. to about 100° C., in one aspect, the disclosed PGEs may have a melt transition temperature of equal to or less than about 55° C.
In one aspect, the fatty acid carbon chain length may be from about 10 to 22, or about 12 to 18 or about 16 to 18 carbon atoms.
In one aspect, n, for Formula I above, may be about 1.5 to about 6, or about 1.5 to about 3.5 or about 1.5 to about 4.5 or about 1.5 to about 5.
In one aspect, the composition may comprise a PGE of Formula I wherein each R is independently selected from the group consisting of fatty acid ester moieties comprising carbon chains, said carbon chains having a carbon chain length of from about 10 to about 22 carbon atoms; OH; and combinations thereof;

wherein
a) when n may be from about 1.5 to about 6, the average % esterification of the PGE may be from about 20% to about 100%;
b) when n may be from about 1.5 to about 5, the average % esterification may be from about 20% to about 90%
c) when n may be from about 1.5 to about 4, the average % esterification may be from about 20% to about 80%;

wherein more than about 50% of the PGE mixture has at least two ester linkages.

In another aspect, the composition may comprise a PGE of Formula I
wherein the fatty acid moieties' carbon chains have an average chain length of from about 10 to about 22 carbon atoms;
wherein the PGE has an iodine value of about 0 to about 145;
wherein
   a) when n may be from about 3 to about 6, the % esterification may be from about 20% to about 100%;
   b) when n may be from about 3 to about 6, the % esterification may be from about 25% to about 90%; and
   c) when n may be from about 3 to about 6, the % esterification may be from about 35% to about 90%.
      In yet another aspect, the composition may comprise a PGE of Formula I wherein the fatty acid moieties' carbon chains have an average carbon chain length of about 16 to 18 carbon atoms;

wherein the PGE has an iodine value of from about 0 to about 20;

wherein
a) when n may be from about 1.5 to about 3.5, the % esterification may be from about 20% to about 60%;
b) when n may be from about 1.5 to about 4.5, the % esterification may be from about 20% to about 70%; and
c) when n may be from about 1.5 to about 6, the % esterification may be from about 20% to about 80%.
   In yet another aspect, the composition may comprise a PGE of Formula I
wherein the fatty acid moieties' carbon chains have an average carbon chain length of from about 16 to about 18 carbon atoms;
wherein the PGE has an iodine value of about 18 to about 135; and
wherein
   a) when n may be from about 1.5 to about 3, the % esterification may be from about 70% to about 100%;
   b) when n may be from about 1.5 to about 4.5, the % esterification may be from about 50% to 100%; and
   c) when n may be from about 1.5 to about 6, the % esterification may be from about 25% to 60%.
      In a yet further aspect, the composition may comprise a PGE of Formula I,
      wherein
a) when n may be from about 3 to about 6, the % esterification may be from about 15% to about 100%;
b) when n may be from about 3 to about 6, the % esterification may be from about 25% to about 90%;
c) when n may be from about 3 to about 6, the % esterification may be from about 35% to about 90%.
   Exemplary commercially available PGEs include Mazol® PGO 31K, Mazol® PGO 104K from BASF; Caprol® MPGO, Caprol® ET from Abitec Corp.; Grindsted® PGE 382, Grindsted®PGE 55, Grindsted® PGE 60 from Danisco; Varonic® 14, TegoSoft® PC 31, Isolan® GO 33, Isolan® GI 34 from Evonik Industries.
   In one aspect, the composition may comprise a PGE of Formula I wherein the fatty acid moieties' carbon chains have an average carbon chain length of about 12 to 18 carbon atoms and an iodine value of about 0 to about 145, and when n may be from about 1.5 to about 6, the % esterification may be from about 20% to 80%.
   In another aspect, the composition may comprise a PGE having the structure of Formula I, wherein each R may be independently selected from the group consisting of fatty acids having carbon chain lengths of about 12 to 18 carbon atoms, fatty acid moieties having carbon chain lengths of about 15 to 18 carbon atoms, OH, and mixtures thereof; wherein the fatty acid may be selected from the group consisting of saturated fatty acids, unsaturated fatty acids, and combinations thereof.
   In one aspect, the fatty acid may be saturated, having an IV of about 0 to about 20.
   In one aspect, the fatty acid may be branched, linear, or further functionalized, for example, by modification such that the fatty acid contains one or more hydroxyl groups.
   In one aspect, at least 50%, or at least 75%, of the PGE molecules comprise at least two ester linkages.
   The degree of oligomerization which is represented by “n” is generally understood to be an average representing a distribution of oligomers. While applicants have recognized that the number of polyglycerol units may be as large as greater than about 10, such molecules have decreased biodegradability and are therefore disfavored. The structure of Formula I is intended to include both linear and/or branched structures. The control of the degree and distribution of oligomers may be controlled to some extent by either physical means (e.g., distillation) or by varying the reaction conditions, as described in U.S. Pat. No. 6,620,904.
   In another aspect, the PGEs may further comprise one or more cyclic polyglycerol (“CPG”). In addition to the above oligomerization reaction, an equivalent intramolecular reaction can occur within an oligomer to for a cyclic analog to the oligomer. The formation of cyclic groups reduces the number of free OH groups relative to non-cyclics. The % cyclic, as used herein, indicates the percent of PGE's having a cyclic group. Applicants have observed that as chain length increases, biodegradability of the PGE decreases. Without intending to be limited by theory, applicants believe that the decrease in biodegradability could be attributed to either the increase in oligomerization itself, or rather, to the increase in cyclic structures that are prone to occur as oligomerization may be increased, or to a combination of both.
   In one aspect, the mixture of polyglycerol esters may comprise, based on total weight, from about 5% to about 70%, or from about 10% to about 50%, or from about 15% to about 30% of a cyclic polyglycerol.
   In one aspect, the final fabric softening composition may comprise, based on total weight of the composition, from about 2% to about 50%, or from about 2% to about 40%, or from about 3% to about 30%, or from about 2% to about 30% of a mixture of PGEs. Alternatively the final fabric softening composition may comprise, based on total weight of the composition, from about from about 4% to about 40% of a mixture of PGEs.
   In one aspect, the composition may comprise a PGE comprising a diester. In one aspect, the PGE may comprise, based on total weight of the PGE, from about 50% to about 100% of a diester. In yet another aspect, the PGEs of the instant composition comprise a diester, a triester, a tetraester, a hexaester or an octaester, for example, greater than about 50% of a diester, a triester, a tetraester, pentaester, a hexaester, a heptaester, or an octaester, or combinations thereof.
   In one aspect, the PGE may comprise, based on total weight of the PGE, from about 50% to 100%, or from about 75% to about 90%, of an ester linkage selected from the group consisting of a diester, a triester, a tetraester, a hexaester, a heptaester, an octaester, and combinations thereof.
   In a yet further aspect, from about 1% to about 50% or from about 5% to about 20% or less than about 10% of the PGE may comprise a monoester.

### Other Components

The disclosed compositions may include additional components. The following is a non-limiting list of suitable additional components.
The compositions may comprise a “delivery enhancing agent.” As used herein, such term refers to any polymer or combination of polymers that significantly enhance the deposition of the fabric care benefit agent onto the fabric during laundering (ie. a deposition aid). In one aspect, the fabric treatment composition may comprise from about 0.01% to about 20%, or from about 0.01% to about 10%, from about 0.05% to about 5% of a deposition aid. In another aspect, the fabric treatment composition may comprise or from about 0.01% to about 20%, from about 0.1% to about 15%, from about 0.15% to about 10%, or from about 0.15% to about 5%, or from about 0.15% to about 3% of a deposition aid. Suitable deposition aids are disclosed in, for example, in U.S. Pat. No. 6,642,200 and in USPA No. 2011/0177994 A1.
In order to drive the fabric care benefit agent onto the fabric; the net charge of the delivery enhancing agent is preferably positive in order to overcome the repulsion between the fabric care benefit agent and the fabric since most fabrics are comprised of textile fibers that have a slightly negative charge in aqueous environments. Examples of fibers exhibiting a slightly negative charge in water include but are not limited to cotton, rayon, silk, wool, etc.
Preferably, the delivery enhancing agent is a cationic or amphoteric polymer. The amphoteric polymers of the present invention will also have a net cationic charge, i.e. the total cationic charges on these polymers will exceed the total anionic charge. The cationic charge density of the polymer ranges from about 0.05 milliequivalents/g to about 23 milliequivalents/g. The charge density is calculated by dividing the number of net charge per repeating unit by the molecular weight of the repeating unit. In one embodiment, the charge density varies from about 0.05 milliequivants/g to about 8 milliequivalents/g. The positive charges could be on the backbone of the polymers or the side chains of polymers.
Nonlimiting examples of delivery enhancing agents are cationic or amphoteric polysaccharides, proteins and synthetic polymers.
a. Cationic Polysaccharides:
Cationic polysaccharides include but not limited to cationic cellulose derivatives, cationic guar gum derivatives, chitosan and derivatives and cationic starches. Cationic polysacchrides have a molecular weight from about 50,000 to about 2 million, preferably from about 100,000 to about 1,500,000.
One group of preferred cationic polysaccharides is shown below:

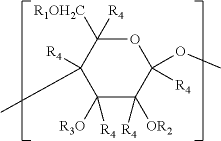

wherein R¹, R², R³ are each independently H, C₁₋₂₄ alkyl (linear or branched),

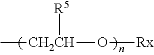

wherein n is from about 0 to about 10; Rx is H, C₁₋₂₄ alkyl (linear or branched) or

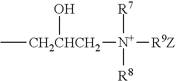

or mixtures thereof, wherein Z is a water soluble anion, preferably chloride, bromide iodide, hydroxide, phosphate sulfate, methyl sulfate and acetate; R⁵ is selected from H, or C₁-C₆ alkyl or mixtures thereof; R⁷, R⁸ and R⁹ are selected from H, or C₁-C₂₈ alkyl, benzyl or substituted benzyl or mixtures thereof
R⁴ is H or —(P)ₘ—H, or mixtures thereof; wherein P is a repeat unit of an addition polymer formed by a cationic monomer. In one embodiment, the cationic monomer is selected from methacrylamidotrimethylammonium chloride, dimethyl diallyl ammonium having the formula:

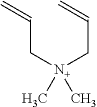

which results in a polymer or co-polymer having units with the formula:

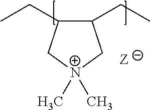

wherein Z′ is a water-soluble anion, preferably chloride, bromide iodide, hydroxide, phosphate sulfate, methyl sulfate and acetate or mixtures thereof and m is from about 1 to about 100. Alkyl substitution on the saccharide rings of the polymer ranges from about 0.01% to 5% per sugar unit, more preferably from about 0.05% to 2% per glucose unit, of the polymeric material.
Preferred cationic polysaccahides include cationic hydroxyalkyl celluloses. Examples of cationic hydroxyalkyl cellulose include those with the INCI name Polyquaternium10 such as those sold under the trade names Ucare Polymer JR 30M, JR 400, JR 125, LR 400 and LK 400 polymers; Polyquaternium 67 sold under the trade name Softcat SK™, all of which are marketed by Amerchol Corporation Edgewater N.J.; and Polyquaternium 4 sold under the trade name Celquat H200 and Celquat L-200 available from National Starch and Chemical Company, Bridgewater, N.J. Other preferred polysaccharides include hydroxyethyl cellulose or hydroxypropylcellulose quaternized with glycidyl C₁₂-C₂₂ alkyl dimethyl ammonium chloride. Examples of such polysaccahrides include the polymers with the INCI names Polyquaternium 24 sold under the trade name Quaternium LM 200, PG-Hydroxyethylcellulose Lauryldimonium Chloride sold under the trade name Crodacel LM, PG-Hydroxyethylcellulose Cocodimonium Chloride sold under the trade name Crodacel QM and, PG-Hydroxyethylcellulose stearyldimonium Chloride sold under the trade name Crodacel QS and alkyldimethylammonium hydroxypropyl oxyethyl cellulose.
In one embodiment of the present invention, the cationic polymer comprises cationic starch. These are described by D. B. Solarek in Modified Starches, Properties and Uses published by CRC Press (1986) and in U.S. Pat. No. 7,135,451, col. 2, line 33-col. 4, line 67. In another embodiment, the cationic starch of the present invention comprises amylose at a level of from about 0% to about 70% by weight of the cationic starch. In yet another embodiment, when the cationic starch comprises cationic maize starch, said cationic starch comprises from about 25% to about 30% amylose, by weight of the cationic starch. The remaining polymer in the above embodiments comprises amylopectin.
A third group of preferred polysaccahrides are cationic galactomanans, such as cationic guar gums or cationic locust bean gum. Example of cationic guar gum is a quaternary ammonium derivative of Hydroxypropyl Guar sold under the trade name Jaguar C13 and Jaguar Excel available from Rhodia, Inc of Cranburry N.J. and N-Hance by Aqualon, Wilmington, Del.
b. Synthetic Cationic Polymers
Cationic polymers in general and their method of manufacture are known in the literature. For example, a detailed description of cationic polymers can be found in an article by M. Fred Hoover that was published in the Journal of Macromolecular Science-Chemistry, A4(6), pp 1327-1417, October, 1970. The entire disclosure of the Hoover article is incorporated herein by reference. Other suitable cationic polymers are those used as retention aids in the manufacture of paper. They are described in “Pulp and Paper, Chemistry and Chemical Technology Volume III edited by James Casey (1981). The Molecular weight of these polymers is in the range of 2000-5 million Da. The synthetic cationic polymers of this invention will be better understood when read in light of the Hoover article and the Casey book, the present disclosure and the Examples herein.

i. Addition Polymers

Synthetic polymers include but are not limited to synthetic addition polymers of the general structure

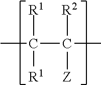

wherein R¹, R², and Z are defined herein below. Preferably, the linear polymer units are formed from linearly polymerizing monomers. Linearly polymerizing monomers are defined herein as monomers which under standard polymerizing conditions result in a linear or branched polymer chain or alternatively which linearly propagate polymerization. The linearly polymerizing monomers of the present invention have the formula:

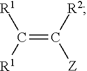

however, those of skill in the art recognize that many useful linear monomer units are introduced indirectly, inter alia, vinyl amine units, vinyl alcohol units, and not by way of linearly polymerizing monomers. For example, vinyl acetate monomers once incorporated into the backbone are hydrolyzed to form vinyl alcohol units. For the purposes of the present invention, linear polymer units may be directly introduced, i.e. via linearly polymerizing units, or indirectly, i.e. via a precursor as in the case of vinyl alcohol cited herein above.

Each R¹ is independently hydrogen, C₁-C₁₂ alkyl, substituted or unsubstituted phenyl, substituted or unsubstituted benzyl, —ORₐ, or —C(O)ORₐ wherein Rₐ is selected from hydrogen, and C₁-C₂₄ alkyl and mixtures thereof. Preferably R¹ is hydrogen, C₁-C₄ alkyl, or —ORₐ, or —C(O)ORₐ

Each R² is independently hydrogen, hydroxyl, halogen, C₁-C₁₂ alkyl, —ORₐ, substituted or unsubstituted phenyl, substituted or unsubstituted benzyl, carbocyclic, heterocyclic, and mixtures thereof. Preferred R² is hydrogen, C₁-C₄ alkyl, and mixtures thereof.

Each Z is independently hydrogen, halogen; linear or branched C1-C30 alkyl, nitrilo, N(R₃)₂—C(O)N(R₃)₂; —NHCHO (formamide);

—OR³, —O(CH₂)ₙN(R³)₂, —O(CH₂)ₙN⁺(R³)₃X⁻, —C(O)OR⁴; —C(O)N—(R³)₂—C(O)O(CH₂)ₙN(R³)₂, —C(O)O(CH₂)ₙN⁺(R³)₃X⁻, —OCO(CH₂)ₙN(R³)₂, —OCO(CH₂)ₙN⁺(R³)₃X⁻, —C(O)NH—(CH₂)ₙN(R³)₂, —C(O)NH(CH₂)ₙN⁺(R³)₃X⁻, —(CH₂)ₙN(R³)₂, —(CH₂)ₙN⁺(R³)₃X⁻,
each R₃ is independently hydrogen, C₁-C₂₄ alkyl, C₂-C₈ hydroxyalkyl, benzyl; substituted benzyl and mixtures thereof;
each R₄ is independently hydrogen or C₁-C₂₄ alkyl, and

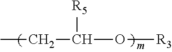

X is a water soluble anion; the index n is from 1 to 6.
R₅ is independently hydrogen, C₁-C₆ alkyl,
and mixtures thereof
   Z can also be selected from non-aromatic nitrogen heterocycle comprising a quaternary ammonium ion, heterocycle comprising an N-oxide moiety, an aromatic nitrogen containing heterocyclic wherein one or more or the nitrogen atoms is quaternized; an aromatic nitrogen containing heterocycle wherein at least one nitrogen is an N-oxide; or mixtures thereof. Non-limiting examples of addition polymerizing monomers comprising a heterocyclic Z unit includes 1-vinyl-2-pyrrolidinone, 1-vinylimidazole, quaternized vinyl imidazole, 2-vinyl-1,3-dioxolane, 4-vinyl-1-cyclohexene1,2-epoxide, and 2-vinylpyridine, 2-vinylpyridine N-oxide, 4-vinylpyridine 4-vinylpyridine N-oxide.
   A non-limiting example of a Z unit which can be made to form a cationic charge in situ is the —NHCHO unit, formamide. The formulator can prepare a polymer or co-polymer comprising formamide units some of which are subsequently hydrolyzed to form vinyl amine equivalents.
   The polymers and co-polymers of the present invention comprise Z units which have a cationic charge or which result in a unit which forms a cationic charge in situ. When the co-polymers of the present invention comprise more than one Z unit, for example, Z¹, Z², . . . Zⁿ units, at least about 1% of the monomers which comprise the co-polymers will comprise a cationic unit.
   The polymers or co-polymers of the present invention can comprise one or more cyclic polymer units which are derived from cyclically polymerizing monomers. Cyclically polymerizing monomers are defined herein as monomers which under standard polymerizing conditions result in a cyclic polymer residue as well as serving to linearly propagate polymerization. Preferred cyclically polymerizing monomers of the present invention have the formula:

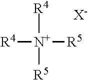

wherein each R⁴ is independently an olefin comprising unit which is capable of propagating polymerization in addition to forming a cyclic residue with an adjacent R⁴ unit; R⁵ is C₁-C₁₂ linear or branched alkyl, benzyl, substituted benzyl, and mixtures thereof; X is a water soluble anion.
Non-limiting examples of R⁴ units include allyl and alkyl substituted allyl units. Preferably the resulting cyclic residue is a six-member ring comprising a quaternary nitrogen atom.

R⁵ is preferably C₁-C₄ alkyl, preferably methyl.

An example of a cyclically polymerizing monomer is dimethyl diallyl ammonium having the formula:

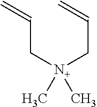

which results in a polymer or co-polymer having units with the formula:

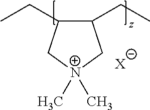

wherein preferably the index z is from about 10 to about 50,000.
Nonlimiting examples of preferred polymers according to the present invention include copolymers made from one or more cationic monomers selected from the group consisting

a) N,N-dialkylaminoalkyl methacrylate, N,N-dialkylaminoalkyl acrylate, N,N-dialkylaminoalkyl acrylamide, N,N-dialkylaminoalkylmethacrylamide, quaternized N,N-dialkylaminoalkyl methacrylate, quaternized N,N-dialkylaminoalkyl acrylate, quaternized N,N-dialkylaminoalkyl acrylamide, quaternized N,N-dialkylaminoalkylmethacrylamide

b) vinylamine and its derivatives, allylamine and its derivatives,

c) vinyl imidazole, quaternized vinyl imidazole and diallyl dialkyl ammonium chloride.

d) And combination thereof.

And optionally a second monomer selected from a group consisting of acrylamide, N,N-dialkyl acrylamide, methacrylamide, N,N-dialkylmethacrylamide, C₁-C₁₂ alkyl acrylate, C₁-C₁₂ hydroxyalkyl acrylate, polyalkylene glyol acrylate, C₁-C₁₂ alkyl methacrylate, C₁-C₁₂ hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole and derivatives, vinyl caprolactam and derivatives, acrylic acid, methacrylic acid, maleic acid, vinyl sulfonic acid, styrene sulfonic acid, acrylamidopropylmethane sulfonic acid (AMPS) and their salts.
The polymer may be a terpolymer made from more than two monomers. The polymer may optionally be branched or cross-linked. Branching and cross-linking monomers include, but are not limited to, ethylene glycol diacrylatate, divinylbenzene, butadiene, and tetraallylammonium chloride.

In one aspect, the cationic polymer may comprise charge neutralizing anions such that the overall polymer is neutral under ambient conditions. Suitable counter ions include (in addition to anionic species generated during use) include chloride, bromide, sulfate, methylsulfate, sulfonate, methylsulfonate, carbonate, bicarbonate, formate, acetate, citrate, nitrate, and mixtures thereof.

Preferred cationic monomers include N,N-dimethyl aminoethyl acrylate, N,N-dimethyl aminoethyl methacrylate (DMAM), [2-(methacryloylamino)ethyl]tri-methylammonium chloride (QDMAM), N,N-dimethylaminopropyl acrylamide (DMAPA), N,N-dimethylaminopropyl methacrylamide (DMAPMA), acrylamidopropyl trimethyl ammonium chloride, methacrylamidopropyl trimethylammonium chloride (MAPTAC), methacryloamidopropyl-pentamethyl-1,3-propylene-2-ol-ammonium dichloride, N,N,N,N′,N′,N″,N″-heptamethyl-N″-3-(1-oxo-2-methyl-2-propenyl)aminopropyl-9-oxo-8-azo-decane-1,4,10-triammonium trichloride, vinylamine and its derivatives, allylamine and its derivatives, vinyl imidazole, quaternized vinyl imidazole and diallyldimethylammonium chloride and derivatives thereof.

Preferred second comonomers include acrylamide, N,N-dimethyl acrylamide, N,N-dimethyl methacrylamide, C1-C4 alkyl acrylate, C1-C4 hydroxyalkylacrylate, acrylic acid, vinyl pyrrolidone, vinyl caprolactam and derivatives, vinyl formamide, vinyl acetamide, vinyl alkyl ether, vinyl pyridine, vinyl acetate, and vinyl alcohol. Most preferred nonionic monomers are acrylamide, hydroxyethyl acrylate (HEA), hydroxypropyl acrylate and derivatives thereof.

In one aspect, the cationic polymer may be selected from the group consisting of poly(acrylamide-co-diallyldimethylammonium chloride), poly(acrylamide-methacrylamidopropyltrimethyl ammonium chloride), poly(acrylamide-co-N,N-dimethyl aminoethyl methacrylate), poly(acrylamide-co-N,N-dimethyl aminoethyl methacrylate), poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamidopropyltrimethylammonium chloride), poly(acrylamide-co-diallyldimethylammonium chloride-co-acrylic acid), poly(acrylamide-methacrylamidopropyltrimethyl ammonium chloride-co-acrylic acid), poly(diallyldimethyl ammonium chloride), poly(vinylpyrrolidone-co-dimethylaminoethyl methacrylate), poly(ethyl methacrylate-co-quaternized dimethylaminoethyl methacrylate), poly(ethyl methacrylate-co-oleyl methacrylate-co-diethylaminoethyl methacrylate), poly(diallyldimethylammonium chloride-co-acrylic acid), poly(vinyl pyrrolidone-co-quaternized vinyl imidazole) and poly(acrylamide-co-methacryloamidopropyl-pentamethyl-1,3-propylene-2-ol-ammonium dichloride). These cationic polymers include and may be further described by the nomenclature Polyquaternium-1, Polyquaternium-5, Polyquaternium-6, Polyquaternium-7, Polyquaternium-8, Polyquaternium-11, Polyquaternium-14, Polyquaternium-22, Polyquaternium-28, Polyquaternium-30, Polyquaternium-32 and Polyquaternium-33, as named under the International Nomenclature for Cosmetic Ingredients.

ii. Polyethyleneimine and its Derivatives

These are commercially available under the trade name Lupasol™ ex. BASF AG of Ludwigschaefen, Germany. In one embodiment, the polyethylene derivative is an amide derivative of polyetheyleneimine sold under the trade name Lupoasol SK. Also included are alkoxylated polyethleneimine; alkyl polyethyleneimine and quaternized polyethyleneimine.

iii. Polyamidoamine-epichlorohydrin (PAE) Resins

PAE resins are condensation products of polyalkylenepolyamine with polycarboxylc acid. The most common PAE resins are the condensation products of diethylenetriamine with adipic acid followed by a subsequent reaction with epichlorohydrin. They are available from Hercules Inc. of Wilmington Del. under the trade name Kymene™ or from BASF A.G. of Ludwigschaefen, Germany under the trade name Luresin™. These polymers are described in Wet Strength resins and their applications edited by L. L. Chan, TAPPI Press(1994), p 13-44.
The delivery enhancing agent, or deposition assisting polymer, has a charge density of about 0.01 to about 23.0 milliequivalents/g (meq/g) of dry polymer, preferably about 0.05 to about 8 meq/g. Charge density is calculated by dividing the number of net charges per repeating unit by the molecular weight of the repeating unit. The positive charges may be located on the backbone of the polymers and/or the side chains of polymers. For amine-containing polymers wherein, the charge density depends on the pH of the composition. For these polymers, charge density is measured at a pH of 7, or the intended use pH of the composition.
In one aspect, the cationic polymers many have a weight-average molecular weight of the polymer from about 500-5,000,000, from about 10,000 and 5,000,000, from about 10,000 to 2,000,000 or from about 2,500 and 1,500,000, as determined by size exclusion chromatography relative to polyethyleneoxide standards with RI detection. The mobile phase used is a solution of 20% methanol in 0.4M MEA, 0.1 M NaNO₃, 3% acetic acid on a Waters Linear Ultrandyrogel column, 2 in series. Columns and detectors are kept at 40° C. Flow is set to 0.5 mL/min.
In another aspect, the delivery enhancing agent may comprise at least one polymer formed from the polymerisation of a) a water soluble ethylenically unsaturated monomer or blend of monomers comprising at least one cationic monomer and at least one non-ionic monomer;
wherein the cationic monomer is a compound according to formula (XV):

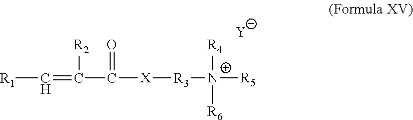

wherein:
R₁ is chosen from hydrogen or methyl, preferably hydrogen;
R₂ is chosen hydrogen, or C₁-C₄ alkyl, preferably hydrogen;
R₃ is chosen C₁-C₄ alkylene, preferably ethylene;
R₄, R₅, and R₆ are each independently chosen from hydrogen, or C₁-C₄ alkyl, preferably methyl;
X is chosen from —O—, or —NH—, preferably —O—; and
Y is chosen from Cl, Br, I, hydrogensulfate, or methosulfate, preferably Cl.
wherein the non-ionic monomer is a compound of formula (XVI):

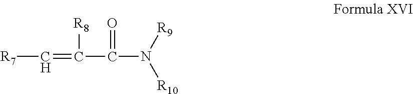

wherein:
R₇ is chosen from hydrogen or methyl, preferably hydrogen;
R₈ is chosen from hydrogen or C₁-C₄ alkyl, preferably hydrogen; and
R₉ and R₁₀ are each independently chosen from hydrogen or C₁-C₄ alkyl, preferably methyl, b) at least one cross-linking agent in an amount from 0.5 ppm to 1000 ppm by the weight of component a), and c) at least one chain transfer agent in the amount of greater than 10 ppm relative to component a), preferably from 1200 ppm to 10,000 ppm, more preferably from 1,500 ppm to 3,000 ppm (as described in USPA No. 2011/0245142 A 1).
In one aspect, the cationic polymer may comprise a cationic acrylic based polymer. In one aspect, the cationic polymer may comprise a cationic polyacrylamide. In one aspect, the cationic polymer may comprise poly(acrylamide-N,N-dimethylaminoethyl acrylate) and its quaternized derivatives. In this aspect, the cationic polymer may be that sold under the tradename Sedipur®, available from BTC Specialty Chemicals, BASF Group, Florham Park, N.J.
In one aspect, the cationic polymer may comprise poly(acrylamide-co-methacrylamidopropyltrimethyl ammonium chloride).
In one aspect, the cationic polymer may comprise a non-acrylamide based polymer, such as that sold under the tradename Rheovis® CDE, available from Ciba Specialty Chemicals, a BASF group, Florham Park, N.J., or as disclosed in USPA 2006/0252668.
In one aspect, the cationic polymer may comprise polyethyleneimine or a polyethyleneimine derivative. In one aspect, the cationic polymer may be a polyethyleneinine such as that sold under the tradename Lupasol® by BASF, AG, Lugwigschaefen, Germany
In one aspect, the cationic polymer may include alkylamine-epichlorohydrin polymers, which are reaction products of amines and oligoamines with epicholorohydrin. These include those polymers listed in U.S. Pat. Nos. 6,642,200 and 6,551,986. Examples include dimethylamine-epichlorohydrin-ethylenediamine, and available under the trade name Cartafix® CB and Cartafix® TSF from Clariant, Basle, Switzerland.
In one aspect, the cationic polymer may be selected from the group consisting of cationic or amphoteric polysaccharides. In one aspect, the cationic polymer may comprise a polymer selected from the group consisting of cationic and amphoteric cellulose ethers, cationic or amphoteric galactomanan, cationic guar gum, cationic or amphoteric starch, and combinations thereof. An example of cationic guar gum is a quaternary ammonium derivative of Hydroxypropyl Guar sold under the trade name Jaguar C13 and Jaguar Excel available from Rhodia, Inc of Cranburry N.J. and N-Hance by Aqualon, Wilmington, Del.

### Silicones

Suitable silicones comprise Si—O moieties and may be selected from (a) non-functionalized siloxane polymers, (b) functionalized siloxane polymers, and combinations thereof. The molecular weight of the organosilicone is usually indicated by the reference to the viscosity of the material. In one aspect, the organosilicones may comprise a viscosity of from about 10 to about 2,000,000 centistokes at 25° C. In another aspect, suitable organosilicones may have a viscosity of from about 10 to about 800,000 centistokes at 25° C.
Suitable organosilicones may be linear, branched or cross-linked. In one aspect, the organosilicones may comprise of silicone resins. Silicone resins are highly cross-linked polymeric siloxane systems. The cross-linking is introduced through the incorporation of trifunctional and tetrafunctional silanes with monofunctional or difunctional, or both, silanes during manufacture of the silicone resin. As used herein, the nomenclature SiO“n”/2 represents the ratio of oxygen and silicon atoms. For example, SiO_{1/2} means that one oxygen is shared between two Si atoms. Likewise SiO_{2/2} means that two oxygen atoms are shared between two Si atoms and SiO_{3/2} means that three oxygen atoms are shared are shared between two Si atoms.

Silicone materials and silicone resins in particular, can conveniently be identified according to a shorthand nomenclature system known to those of ordinary skill in the art as “MDTQ” nomenclature. Under this system, the silicone is described according to presence of various siloxane monomer units which make up the silicone. Briefly, the symbol M denotes the monofunctional unit (CH₃)₃SiO_{0.5}; D denotes the difunctional unit (CH₃)₂SiO; T denotes the trifunctional unit (CH₃)SiO_{1.5}; and Q denotes the quadra- or tetra-functional unit SiO₂. Primes of the unit symbols (e.g. M′, D′, T′, and Q′) denote substituents other than methyl, and must be specifically defined for each occurrence.

In one aspect, silicone resins for use in the compositions of the present invention include, but are not limited to MQ, MT, MTQ, MDT and MDTQ resins. In one aspect, Methyl is a highly suitable silicone substituent. In another aspect, silicone resins are typically MQ resins, wherein the M:Q ratio is typically from about 0.5:1.0 to about 1.5:1.0 and the average molecular weight of the silicone resin is typically from about 1000 to about 10,000.

Other modified silicones or silicone copolymers are also useful herein. Examples of these include silicone-based quaternary ammonium compounds (Kennan quats) disclosed in U.S. Pat. Nos. 6,607,717 and 6,482,969; end-terminal quaternary siloxanes; silicone aminopolyalkyleneoxide block copolymers disclosed in U.S. Pat. Nos. 5,807,956 and 5,981,681; hydrophilic silicone emulsions disclosed in U.S. Pat. No. 6,207,782; and polymers made up of one or more crosslinked rake or comb silicone copolymer segments disclosed in U.S. Pat. No. 7,465,439. Additional modified silicones or silicone copolymers useful herein are described in US Patent Application No. 2007/0286837A1.

In alternative embodiments of the present invention, the above-noted silicone-based quaternary ammonium compounds may be combined with the silicone polymers described in U.S. Pat. Nos. 7,041,767 and 7,217,777 and US Application number 2007/0041929A1.

In one aspect, the organosilicone may comprise a non-functionalized siloxane polymer that may have Formula (XVII) below, and may comprise polyalkyl and/or phenyl silicone fluids, resins and/or gums.

[R₁R₂R₃SiO_{1/2}]ₙ[R₄R₄SiO_{2/2}]ₘ[R₄SiO_{3/2}]ⱼ Formula (XVII)

wherein:
i) each R₁, R₂, R₃ and R₄ may be independently selected from the group consisting of H, —OH, C₁-C₂₀ alkyl, C₁-C₂₀ substituted alkyl, C₆-C₂₀ aryl, C₆-C₂₀ substituted aryl, alkylaryl, and/or C₁-C₂₀ alkoxy, moieties;
ii) n may be an integer from about 2 to about 10, or from about 2 to about 6; or 2; such that n=j+2;
iii) m may be an integer from about 5 to about 8,000, from about 7 to about 8,000 or from about 15 to about 4,000;
iv) j may be an integer from 0 to about 10, or from 0 to about 4, or 0;

In one aspect, R₂, R₃ and R₄ may comprise methyl, ethyl, propyl, C₄-C₂₀ alkyl, and/or C₆-C₂₀ aryl moieties. In one aspect, each of R₂, R₃ and R₄ may be methyl. Each R₁ moiety blocking the ends of the silicone chain may comprise a moiety selected from the group consisting of hydrogen, methyl, methoxy, ethoxy, hydroxy, propoxy, and/or aryloxy.

In one aspect, the organosilicone may be polydimethylsiloxane, dimethicone, dimethiconol, dimethicone crosspolymer, phenyl trimethicone, alkyl dimethicone, lauryl dimethicone, stearyl dimethicone and phenyl dimethicone. Examples include those available under the names DC 200 Fluid, DC 1664, DC 349, DC 346G available from Dow Corning® Corporation, Midland, Mich., and those available under the trade names SF1202, SF1204, SF96, and Viscasil® available from Momentive Silicones, Waterford, N.Y.

In one aspect, the organosilicone may comprise a cyclic silicone. The cyclic silicone may comprise a cyclomethicone of the formula [(CH₃)₂SiO]ₙ where n is an integer that may range from about 3 to about 7, or from about 5 to about 6.

In one aspect, the organosilicone may comprise a functionalized siloxane polymer. Functionalized siloxane polymers may comprise one or more functional moieties selected from the group consisting of amino, amido, alkoxy, hydroxy, polyether, carboxy, hydride, mercapto, sulfate phosphate, and/or quaternary ammonium moieties. These moieties may be attached directly to the siloxane backbone through a bivalent alkylene radical, (i.e., “pendant”) or may be part of the backbone. Suitable functionalized siloxane polymers include materials selected from the group consisting of aminosilicones, amidosilicones, silicone polyethers, silicone-urethane polymers, quaternary ABn silicones, amino ABn silicones, and combinations thereof.

In one aspect, the functionalized siloxane polymer may comprise a silicone polyether, also referred to as “dimethicone copolyol.” In general, silicone polyethers comprise a polydimethylsiloxane backbone with one or more polyoxyalkylene chains. The polyoxyalkylene moieties may be incorporated in the polymer as pendent chains or as terminal blocks. Such silicones are described in USPA 2005/0098759, and U.S. Pat. Nos. 4,818,421 and 3,299,112. Exemplary commercially available silicone polyethers include DC 190, DC 193, FF400, all available from Dow Corning® Corporation, and various Silwet® surfactants available from Momentive Silicones.

In another aspect, the functionalized siloxane polymer may comprise an aminosilicone. Suitable aminosilicones are described in U.S. Pat. Nos. 7,335,630 B2, 4,911,852, and USPA 2005/0170994A1. In one aspect the aminosilicone may be that described in U.S. PA 61/221,632. In another aspect, the aminosilicone may comprise the structure of Formula (XVIII):

[R₁R₂R₃SiO_{1/2}]ₙ[(R₄Si(X—Z)O_{2/2}]ₖ[R₄R₄SiO_{2/2}]ₘ[R₄SiO_{3/2}]ⱼ Formula (XVIII)

wherein
i. R₁, R₂, R₃ and R₄ may each be independently selected from H, OH, C₁-C₂₀ alkyl, C₁-C₂₀ substituted alkyl, C₆-C₂₀ aryl, C₆-C₂₀ substituted aryl, alkylaryl, and/or C₁-C₂₀ alkoxy;
ii. Each X may be independently selected from a divalent alkylene radical comprising 2-12 carbon atoms, —(CH₂)ₛ— wherein s may be an integer from about 2 to about 10; —CH₂—CH(OH)—CH₂—; and/or

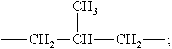

iii. Each Z may be independently selected from —N(R₅)₂; —

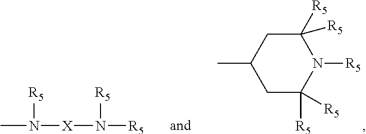

wherein each R₅ may be selected independently selected from H, C₁-C₂₀ alkyl; and A⁻ may be a compatible anion. In one aspect, A⁻ may be a halide;
iv. k may be an integer from about 3 to about 20, from about 5 to about 18 more or even from about 5 to about 10;
v. m may be an integer from about 100 to about 2,000, or from about 150 to about 1,000;
vi. n may be an integer from about 2 to about 10, or about 2 to about 6, or 2, such that n=j+2; and
vii. j may be an integer from 0 to about 10, or from 0 to about 4, or 0;
   In one aspect, R₁ may comprise —OH. In this aspect, the organosilicone is amidomethicone. Exemplary commercially available aminosilicones include DC 8822, 2-8177, and DC-949, available from Dow Corning® Corporation, and KF-873, available from Shin-Etsu Silicones, Akron, Ohio.
   In one aspect the silicone may be chosen from a random or blocky organosilicone polymer having the following formula (XIX):

[R₁R₂R₃SiO_{1/2}]₍ⱼ₊₂₎[(R₄Si(X—Z)O_{2/2}]ₖ[R₄R₄SiO_{2/2}]ₘ[R₄SiO_{3/2}]ⱼ Formula (XIX)

wherein:
j is an integer from 0 to about 98; in one aspect j is an integer from 0 to about 48; in one aspect, j is 0;
k is an integer from 0 to about 200, in one aspect k is an integer from 0 to about 50; when k=0, at least one of R₁, R₂ or R₃ is —X—Z;
m is an integer from 4 to about 5,000; in one aspect m is an integer from about 10 to about 4,000; in another aspect m is an integer from about 50 to about 2,000;
R₁, R₂ and R₃ are each independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and X—Z;
each R₄ is independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy and C₁-C₃₂ substituted alkoxy;
each X in said alkyl siloxane polymer comprises a substituted or unsubsitituted divalent alkylene radical comprising 2-12 carbon atoms, in one aspect each divalent alkylene radical is independently selected from the group consisting of —(CH₂)s- wherein s is an integer from about 2 to about 8, from about 2 to about 4;
in one aspect, each X in said alkyl siloxane polymer comprises a substituted divalent alkylene radical selected from the group consisting of: —CH₂—CH(OH)—CH₂—; —CH₂—CH₂—CH(OH)—; and

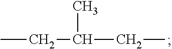

each Z is selected independently from the group consisting of

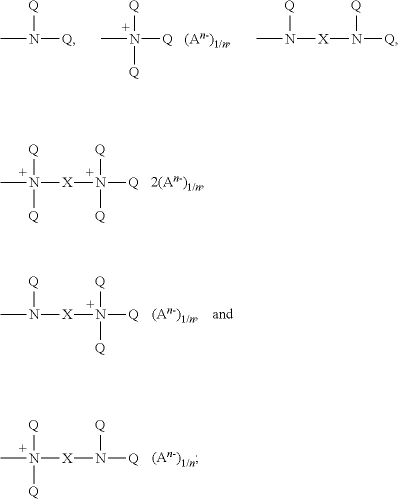

with the proviso that when Z is a quat, Q cannot be an amide, imine, or urea moiety;
for Z Aⁿ⁻ is a suitable charge balancing anion. In one aspect Aⁿ⁻ is selected from the group consisting of Cl⁻, Br⁻, I⁻, methylsulfate, toluene sulfonate, carboxylate and phosphate; and at least one Q in said organosilicone is independently selected from

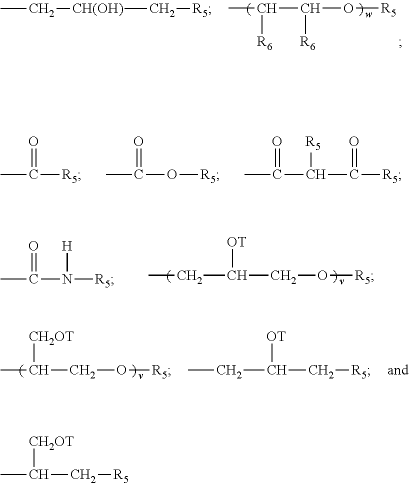

each additional Q in said organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —CH₂—

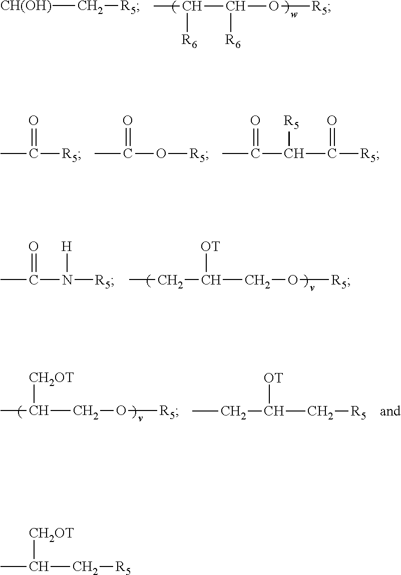

wherein each R₅ is independently selected from the group consisting of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —(CHR₆—CHR₆—O—)_{w}-L and a siloxyl residue;
each R₆ is independently selected from H, C₁-C₁₈ alkyl
each L is independently selected from —C(O)—R₇ or R₇;
w is an integer from 0 to about 500, in one aspect w is an integer from about 1 to about 200; in one aspect w is an integer from about 1 to about 50;
each R₇ is selected independently from the group consisting of H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl; C₆-C₃₂ substituted alkylaryl and a siloxyl residue;
each T is independently selected from H, and

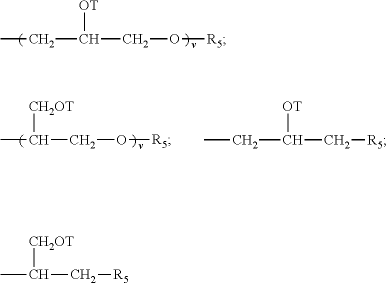

and
wherein each v in said organosilicone is an integer from 1 to about 10, in one aspect, v is an integer from 1 to about 5 and the sum of all v indices in each Q in the said organosilicone is an integer from 1 to about 30 or from 1 to about 20 or even from 1 to about 10.
   In one aspect, the organosilicone may comprise amine ABn silicones and quat ABn silicones. Such organosilicones are generally produced by reacting a diamine with an epoxide. These are described, for example, in U.S. Pat. Nos. 6,903,061 B2, 5,981,681, 5,807,956, 6,903,061 and 7,273,837. These are commercially available under the trade names Magnasoft® Prime, Magnasoft® JSS, Silsoft® A-858 (all from Momentive Silicones).

In another aspect, the functionalized siloxane polymer may comprise silicone-urethanes, such as those described in U.S. PA 61/170,150. These are commercially available from Wacker Silicones under the trade name SLM-212000.

When a sample of organosilicone is analyzed, it is recognized by the skilled artisan that such sample may have, on average, the non-integer indices for Formula (XVII), (XVIII), and (XIX) above, but that such average indices values will be within the ranges of the indices for Formula (XVII), (XVIII), and (XIX) above.

### Perfumes

One aspect of the invention provides for fabric care compositions comprising a perfume. As used herein the term “perfume” is used to indicate any odoriferous material that is subsequently released into the aqueous bath and/or onto fabrics contacted therewith. The perfume will most often be liquid at ambient temperatures. A wide variety of chemicals are known for perfume uses, including materials such as aldehydes, ketones, and esters. More commonly, naturally occurring plant and animal oils and exudates comprising complex mixtures of various chemical components are known for use as perfumes. The perfumes herein can be relatively simple in their compositions or can comprise highly sophisticated complex mixtures of natural and synthetic chemical components, all chosen to provide any desired odor. Examples of perfumes are described, for example, in US 2005/0202990 A1, from paragraphs 47 to 81. Examples of neat perfumes are disclosed in U.S. Pat. Nos. 5,500,138; 5,500,154; 6,491,728; 5,500,137 and 5,780,404. Perfume fixatives and/or perfume carrier materials may also be included. US 2005/0202990 A1, from paragraphs 82-139.

### Benefit Agent Delivery Systems

The compositions disclosed herein may further comprise a benefit agent delivery system, such as a perfume delivery system. Suitable benefit agent delivery systems, methods of making benefit agent delivery systems and the uses of benefit agent delivery systems are disclosed in USPA 2007/0275866 A1. Such benefit agent delivery systems include:

I. Polymer Assisted Delivery (PAD): This benefit agent delivery technology uses polymeric materials to deliver benefit agents (e.g., perfumes). Examples of PAD include employment of classical coacervation, water soluble or partly soluble to insoluble charged or neutral polymers, liquid crystals, hot melts, hydrogels, perfumed plastics, microcapsules, nano- and micro-latexes, polymeric film formers, and polymeric absorbents, polymeric adsorbents, etc. Further, PAD includes but is not limited to:

a.) Matrix Systems: The benefit agent is dissolved or dispersed in a polymer matrix or particle. Perfumes, for example, may be 1) dispersed into the polymer prior to formulating into the product or 2) added separately from the polymer during or after formulation of the product. Suitable organic latex particles include a wide range of materials including, but not limited to, polyacetal, polyacrylate, polyamide, polybutadiene, polychloroprene, polyethylene, polycyclohexylene polycarbonate, polyhydroxyalkanoate, polyketone, polyester, polyetherimide, polyethersulfone, polyethylenechlorinates, polyimide, polyisoprene, polylactic acid, polyphenylene, polyphenylene, polypropylene, polystyrene, polysulfone, polyvinyl acetate, polyvinyl chloride, as well as polymers or copolymers based on amine, acrylonitrile-butadiene, cellulose acetate, ethylene-vinyl acetate, ethylene vinyl alcohol, styrene-butadiene, vinyl acetate-ethylene, and mixtures thereof. All such matrix systems may include, for example, polysaccharides and nanolatexes that may be combined with other perfume delivery technologies, including other PAD systems such as PAD reservoir systems in the form of a perfume microcapsule (PMC). Silicone-assisted delivery (SAD) may also be used. Examples of silicones include polydimethylsiloxane and polyalkyldimethylsiloxanes. Other examples include those with amine functionality, which may be used to provide benefits associated with amine-assisted delivery (AAD) and/or polymer-assisted delivery (PAD) and/or amine-reaction products (ARP).

b.) Reservoir Systems: Reservoir systems are also known as a core-shell system (e.g., perfume microcapsules). In such a system, the benefit agent is surrounded by a benefit agent release controlling membrane, which may serve as a protective shell. Suitable shell materials include reaction products of one or more amines with one or more aldehydes, such as urea cross-linked with formaldehyde or gluteraldehyde, melamine cross-linked with formaldehyde; gelatin-polyphosphate coacervates optionally cross-linked with gluteraldehyde; gelatin-gum Arabic coacervates; cross-linked silicone fluids; polyamine reacted with polyisocyanates, polyamines reacted with epoxides, polyvinyl alcohol cross linked with gluteraldehyde, polydivinyl chloride, polyacrylate, in one aspect said polyacrylate based materials may comprise polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof. polyester, polyamides and mixtures thereof.

Suitable core materials include perfume compositions, perfume raw materials, silicone oils, waxes, hydrocarbons, higher fatty acids, essential oils, lipids, skin coolants, vitamins, sunscreens, antioxidants, glycerine, catalysts, bleach particles, silicon dioxide particles, malodor reducing agents, odor-controlling materials, chelating agents, antistatic agents, softening agents, insect and moth repelling agents, colorants, antioxidants, chelants, bodying agents, drape and form control agents, smoothness agents, wrinkle control agents, sanitization agents, disinfecting agents, germ control agents, mold control agents, mildew control agents, antiviral agents, drying agents, stain resistance agents, soil release agents, fabric refreshing agents and freshness extending agents, chlorine bleach odor control agents, dye fixatives, dye transfer inhibitors, color maintenance agents, optical brighteners, color restoration/rejuvenation agents, anti-fading agents, whiteness enhancers, anti-abrasion agents, wear resistance agents, fabric integrity agents, anti-wear agents, anti-pilling agents, defoamers and anti-foaming agents, UV protection agents for fabrics and skin, sun fade inhibitors, anti-allergenic agents, enzymes, water proofing agents, fabric comfort agents, shrinkage resistance agents, stretch resistance agents, stretch recovery agents, skin care agents, glycerin, and natural actives such as aloe vera, vitamin E, shea butter, cocoa butter, and the like, brighteners, antibacterial actives, antiperspirant actives, cationic polymers, dyes and mixtures thereof. Suitable perfume compositions may comprise enduring perfumes, such as perfume raw materials that have a cLogP greater than about 2.5 and a boiling point greater than about 250° C. Further, suitable perfume compositions may comprise blooming perfumes that comprise perfume raw materials that have a cLogP of greater than about 3 and a boiling point of less than about 260° C.

Suitable core materials being stabilized, emulsified, in the solvent systems with organic or inorganic materials, organic materials can be polymers of anionic, non-ionic nature or cationic nature, like polyacrylates, polyvinyl alcohol. Suitable processes to make core shell systems include coating, extrusion, spray drying, interfacial polymerization, polycondensation, simple coacervation, complex coacervation, free radical polymerization, in situ emulsion polymerization, matrix polymerization and combinations thereof.

Suitable characteristics for core shell systems include:
a) a shell thickness of from about 20 nm to about 500 nm, from about 40 nm to about 250 nm, or from about 60 nm to about 150 nm;
b) a shell core ratio of from about 5:95 to about 50:50, from about 10:90 to about 30:70, or from about 10:90 to about 15:85;
c) a fracture strength of from about 0.1 MPa to about 16 MPa, from about 0.5 MPa to about 8 MPa, or even from about 1 MPa to about 3 MPa; and
d) an average particle size of from about 1 micron to about 100 microns, from about 5 microns to about 80 microns, or even from about 15 microns to about 50 microns.

Suitable deposition and/or retention enhancing coatings that may be applied to the core shell systems include cationic polymers such as polysaccharides including, but not limited to, cationically modified starch, cationically modified guar, polysiloxanes, poly diallyl dimethyl ammonium halides, copolymers of poly diallyl dimethyl ammonium chloride and vinyl pyrrolidone, acrylamides, imidazoles, imidazolinium halides, imidazolium halides, poly vinyl amine, copolymers of poly vinyl amine and N-vinyl formamide and mixtures thereof. In another aspect, suitable coatings may be selected from the group consisting of polyvinylformaldehyde, partially hydroxylated polyvinylformaldehyde, polyvinylamine, polyethyleneimine, ethoxylated polyethyleneimine, polyvinylalcohol, polyacrylates, and combinations thereof.

Suitable methods of physically reducing any residual type materials may be employed, such as centrifugation, to remove undesirable materials. Suitable methods of chemically reducing any residual type materials may also be employed, such as the employment of scavengers, for example formaldehyde scavengers including sodium bisulfite, urea, ethylene urea, cysteine, cysteamine, lysine, glycine, serine, carnosine, histidine, glutathione, 3,4-diaminobenzoic acid, allantoin, glycouril, anthranilic acid, methyl anthranilate, methyl 4-aminobenzoate, ethyl acetoacetate, acetoacetamide, malonamide, ascorbic acid, 1,3-dihydroxyacetone dimer, biuret, oxamide, benzoguanamine, pyroglutamic acid, pyrogallol, methyl gallate, ethyl gallate, propyl gallate, triethanol amine, succinamide, thiabendazole, benzotriazol, triazole, indoline, sulfanilic acid, oxamide, sorbitol, glucose, cellulose, poly(vinyl alcohol), partially hydrolyzed poly(vinylformamide), poly(vinyl amine), poly(ethylene imine), poly(oxyalkyleneamine), poly(vinyl alcohol)-co-poly(vinyl amine), poly(4-aminostyrene), poly(1-lysine), chitosan, hexane diol, ethylenediamine-N,N′-bisacetoacetamide, N-(2-ethylhexyl)acetoacetamide, 2-benzoylacetoacetamide, N-(3-phenylpropyl)acetoacetamide, lilial, helional, melonal, triplal, 5,5-dimethyl-1,3-cyclohexanedione, 2,4-dimethyl-3-cyclohexenecarboxaldehyde, 2,2-dimethyl-1,3-dioxan-4,6-dione, 2-pentanone, dibutyl amine, triethylenetetramine, ammonium hydroxide, benzylamine, hydroxycitronellol, cyclohexanone, 2-butanone, pentane dione, dehydroacetic acid, or a mixture thereof.

II. Molecule-Assisted Delivery (MAD): Non-polymer materials or molecules may also serve to improve the delivery of perfume as perfume may non-covalently interact with organic materials, resulting in altered deposition and/or release. Non-limiting examples of such organic materials include, but are not limited to, hydrophobic materials such as organic oils, waxes, mineral oils, petrolatum, fatty acids or esters, sugars, surfactants, liposomes and even other perfume raw material (perfume oils), as well as natural oils, including body and/or other soils.
III. Fiber-Assisted Delivery (FAD): The choice or use of a situs itself may serve to improve the delivery of perfume. In fact, the situs itself may be a perfume delivery technology. For example, different fabric types such as cotton or polyester will have different properties with respect to ability to attract and/or retain and/or release perfume. The amount of perfume deposited on or in fibers may be altered by the choice of fiber, and also by the history or treatment of the fiber, as well as by any fiber coatings or treatments. Fibers may be pre-loaded with a perfume, and then added to a product that may or may not contain free perfume and/or one or more perfume delivery technologies.
IV. Amine Assisted Delivery (AAD): The amine-assisted delivery technology approach utilizes materials that contain an amine group to increase perfume deposition or modify perfume release during product use. There is no requirement in this approach to pre-complex or pre-react the perfume raw material(s) and the amine prior to addition to the product. In one aspect, amine-containing AAD materials suitable for use herein may be non-aromatic; for example, polyalkylimine, such as polyethyleneimine (PEI), or polyvinylamine (PVAm), or aromatic, for example, anthranilates. Such materials may also be polymeric or non-polymeric. In one aspect, such materials contain at least one primary amine. In another aspect, a material that contains a heteroatom other than nitrogen, for example sulfur, phosphorus or selenium, may be used as an alternative to amine compounds. In yet another aspect, the aforementioned alternative compounds can be used in combination with amine compounds. In yet another aspect, a single molecule may comprise an amine moiety and one or more of the alternative heteroatom moieties, for example, thiols, phosphines and selenols.
V. Cyclodextrin Delivery System (CD): This technology approach uses a cyclic oligosaccharide or cyclodextrin to improve the delivery of perfume. Typically a perfume and cyclodextrin (CD) complex is formed. Such complexes may be preformed, formed in-situ, or formed on or in the situs.

### VI. Starch Encapsulated Accord (SEA):

SEA's are starch encapsulated perfume materials. Suitable starches include modified starches such as hydrolyzed starch, acid thinned starch, starch having hydrophobic groups, such as starch esters of long chain hydrocarbons (C₅ or greater), starch acetates, starch octenyl succinate and mixtures thereof. In one aspect, starch esters, such as starch octenyl succinates are employed. Suitable perfumes for encapsulation include the HIA perfumes including those having a boiling point determined at the normal standard pressure of about 760 mmHg of 275° C. or lower, an octanol/water partition coefficient P of about 2000 or higher and an odour detection thresholdof less than or equal 50 parts per billion (ppb). In one aspect, the perfume may have logP of 2 or higher.

VII. Inorganic Carrier Delivery System (ZIC): This technology relates to the use of porous zeolites or other inorganic materials to deliver perfumes. Perfume-loaded zeolite may be used with or without adjunct ingredients used for example to coat the perfume-loaded zeolite (PLZ) to change its perfume release properties during product storage or during use or from the dry situs. Another example of a suitable inorganic carrier includes inorganic tubules, where the perfume or other active material is contained within the lumen of the nano- or micro-tubules. Monomeric and/or polymeric materials, including starch encapsulation, may be used to coat, plug, cap, or otherwise encapsulate the PLT.
VIII. Pro-Perfume (PP): This technology refers to perfume technologies that result from the reaction of perfume materials with other substrates or chemicals to form materials that have a covalent bond between one or more PRMs and one or more carriers. The PRM is converted into a new material called a pro-PRM (i.e., pro-perfume), which then may release the original PRM upon exposure to a trigger such as water or light. Nonlimiting examples of pro-perfumes include Michael adducts (e.g., beta-amino ketones), aromatic or non-aromatic imines (Schiffs Bases), oxazolidines, beta-keto esters, and orthoesters. Another aspect includes compounds comprising one or more beta-oxy or beta-thio carbonyl moieties capable of releasing a PRM, for example, an alpha, beta-unsaturated ketone, aldehyde or carboxylic ester.

a.) Amine Reaction Product (ARP): For purposes of the present application, ARP is a subclass or species of PP. One may also use “reactive” polymeric amines in which the amine functionality is pre-reacted with one or more PRMs, typically PRMs that contain a ketone moiety and/or an aldehyde moiety, to form an amine reaction product (ARP). Typically, the reactive amines are primary and/or secondary amines, and may be part of a polymer or a monomer (non-polymer). Such ARPs may also be mixed with additional PRMs to provide benefits of polymer-assisted delivery and/or amine-assisted delivery. Nonlimiting examples of polymeric amines include polymers based on polyalkylimines, such as polyethyleneimine (PEI), or polyvinylamine (PVAm). Nonlimiting examples of monomeric (non-polymeric) amines include hydroxyl amines, such as 2-aminoethanol and its alkyl substituted derivatives, and aromatic amines such as anthranilates. The ARPs may be premixed with perfume or added separately in leave-on or rinse-off applications. In another aspect, a material that contains a heteroatom other than nitrogen, for example oxygen, sulfur, phosphorus or selenium, may be used as an alternative to amine compounds. In yet another aspect, the aforementioned alternative compounds can be used in combination with amine compounds. In yet another aspect, a single molecule may comprise an amine moiety and one or more of the alternative heteroatom moieties, for example, thiols, phosphines and selenols.

Suitable perfume delivery systems, methods of making certain perfume delivery systems and the uses of such perfume delivery systems are disclosed in USPA 2007/0275866 A1. In one embodiment, the fabric care composition comprises from about 0.01% to about 5%, alternatively from about 0.5% to about 3%, or from about 0.5% to about 2%, or from about 1% to about 2% neat perfume by weight of the fabric care composition.

In one embodiment, the compositions of the present invention comprises perfume oil encapsulated in a perfume microcapsule (PMC), preferable a friable PMC. In another embodiment, the perfume microcapsule comprises a friable microcapsule. In another embodiment, the shell may comprise an aminoplast copolymer, such as melamine-formaldehyde or urea-formaldehyde or cross-linked melamine formaldehyde or the like. Capsules may be obtained from Appleton Papers Inc., of Appleton, Wis. USA. Formaldehyde scavengers may also be used.

### Fatty Acids

The compositions may optionally contain from about 0.01% to about 10%, or from about 2% to about 7%, or from about 3% to about 5%, by weight the composition, of a fatty acid, wherein, in one aspect, the fatty acid may comprise from about 8 to about 20 carbon atoms. The fatty acid may comprise from about 1 to about 10 ethylene oxide units in the hydrocarbon chain. Suitable fatty acids may be saturated and/or unsaturated and can be obtained from natural sources such a plant or animal esters (e.g., palm kernel oil, palm oil, coconut oil, babassu oil, safflower oil, tall oil, castor oil, tallow and fish oils, grease, or mixtures thereof), or synthetically prepared (e.g., via the oxidation of petroleum or by hydrogenation of carbon monoxide via the Fisher Tropsch process). Examples of suitable saturated fatty acids for use in the compositions include capric, lauric, myristic, palmitic, stearic, arachidic and behenic acid. Suitable unsaturated fatty acid species include: palmitoleic, oleic, linoleic, linolenic and ricinoleic acid. Examples of fatty acids are saturated C12 fatty acid, saturated C12-C14 fatty acids, and saturated or unsaturated C12 to C18 fatty acids, and mixtures thereof.

### Dispersants

The compositions may contain from about 0.1%, to about 10%, by weight of dispersants. Suitable water-soluble organic materials are the homo- or co-polymeric acids or their salts, in which the polycarboxylic acid may contain at least two carboxyl radicals separated from each other by not more than two carbon atoms. The dispersants may also be alkoxylated derivatives of polyamines, and/or quaternized derivatives thereof such as those described in U.S. Pat. Nos. 4,597,898, 4,676,921, 4,891,160, 4,659,802 and 4,661,288.
The dispersants may also be materials according to Formula (XIX):

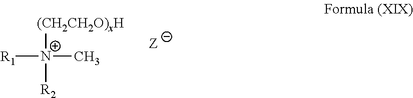

wherein R₁ is C6 to C22 alkyl, branched or unbranched, alternatively C12 to C18 alkyl, branched or unbranched. R₂ is nil, methyl, or —(CH₂CH₂0)_{y}, wherein y is from 2 to 20. When R2 is nil, the Nitrogen will be protonated. x is also from 2 to 20. Z is a suitable anionic counterion, preferably selected from the group consisting of chloride, bromide, methylsulfate, ethylsulfate, sulfate, and nitrate, more preferably chloride or methyl sulfate.
In one embodiment, the dispersant is according to Formula (XX):

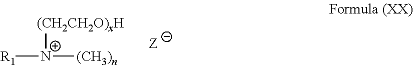

wherein x is from 2 to 20, and wherein R₁ is C6 to C22 alkyl, branched or unbranched, preferably C12 to C18 alkyl, branched or unbranched, and wherein n is 1 or 2. When n is 2, there is an anion. Z is a suitable anionic counterion, preferably selected from the group consisting of chloride, bromide, methylsulfate, ethylsulfate, sulfate, and nitrate, more preferably chloride or methyl sulfate. When n is 1, there is no anion present under acidic conditions. An example of such a material is alkyl polyglycol ether ammonium methylchloride sold under the product name, for example, Berol 648 from Akzo Nobel.

In another embodiment, the dispersant is one according to Formula (XXI):

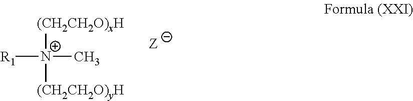

wherein x and y are each independently selection from 2 to 20, and wherein R₁ is C6 to C22 alkyl, branched or unbranched, preferably unbranched. In one embodiment, X+Y is from 2 to 40, preferably from 10 to 20. Z is a suitable anionic counterion, preferably chloride or methyl sulfate. An example of such a material is cocoalkylmethyl ethoxylated ammonium chloride sold under the product name, for example, ETHOQUAD C 25 from Akzo Nobel.

Another aspect of the invention provides for a method of making a perfumed fabric care composition comprising the step of adding the concentrated perfume composition of the present invention to a composition comprising one or more fabric softening actives, wherein preferably the composition comprising the fabric softening active is free or substantially free of a perfume.

The concentrated perfume composition is combined with the composition comprising fabric softening active(s) such that the final fabric softener composition comprises at least 1.5%, alternatively at least 1.7%, or 1.9%, or 2%, or 2.1%, or 2.3%, or 2.5%, or 2.7% or 3%, or from 1.5% to 3.5%, or combinations thereof, of concentrated perfume composition by weight of the final fabric softener composition.

The perfumed fabric care composition comprises a weight ratio of perfume to amphiphile of at least 3 to 1, alternatively 4:1, or 5:1, or 6:1, or 7:1, or 8:1, or 9:1, or 10:1, alternatively not greater than 100:1, respectively.

### Structurants

Compositions of the present invention may contain a structurant or structuring agent. Suitable levels of this component are in the range from about 0.01% to 10%, preferably from 0.01% to 5%, and even more preferably from 0.01% to 3% by weight of the composition. The structurant serves to stabilize silicone polymers and perfume microcapsules in the inventive compositions and to prevent it from coagulating and/or creaming. This is especially important when the inventive compositions have fluid form, as in the case of liquid or the gel-form fabric enhancer compositions.

Structurants suitable for use herein can be selected from gums and other similar polysaccharides, for example gellan gum, carrageenan gum, xanthan gum, Diutan gum (ex. CP Kelco) and other known types of structurants such as Rheovis CDE (ex. BASF), Alcogum L-520 (ex. Alco Chemical), and Sepigel 305 (ex. SEPPIC).

One preferred structurant is a crystalline, hydroxyl-containing stabilizing agent, more preferably still, a trihydroxystearin, hydrogenated oil or a derivative thereof.

Without intending to be limited by theory, the crystalline, hydroxyl-containing stabilizing agent is a nonlimiting example of a “thread-like structuring system” (“thread-like structuring systems” are described in detail in Solomon, M. J. and Spicer, P. T., “Microstructural Regimes of Colloidal Rod Suspensions, Gels, and Glasses,” Soft Matter (2010)). “Thread-like Structuring System” as used herein means a system comprising one or more agents that are capable of providing a physical network that reduces the tendency of materials with which they are combined to coalesce and/or phase split. Examples of the one or more agents include crystalline, hydroxyl-containing stabilizing agents and/or hydrogenated jojoba. Surfactants are not included within the definition of the thread-like structuring system. Without wishing to be bound by theory, it is believed that the thread-like structuring system forms a fibrous or entangled threadlike network. The thread-like structuring system has an average aspect ratio of from 1.5:1, preferably from at least 10:1, to 200:1.

The thread-like structuring system can be made to have a viscosity of 0.002 m²/s (2,000 centistokes at 20° C.) or less at an intermediate shear range (5 s⁻¹ to 50 s⁻¹) which allows for the pouring of the fabric enhancer composition out of a standard bottle, while the low shear viscosity of the product at 0.1 s⁻¹ can be at least 0.002 m²/s (2,000 centistokes at 20° C.) but more preferably greater than 0.02 m²/s (20,000 centistokes at 20° C.). A process for the preparation of a thread-like structuring system is disclosed in WO 02/18528.

Other preferred structurants are uncharged, neutral polysaccharides, gums, celluloses, and polymers like polyvinyl alcohol, polyacrylamides, polyacrylates and co-polymers, and the like.

### Dye Transfer Inhibiting Agents

The compositions may also include from about 0.0001%, from about 0.01%, from about 0.05% by weight of the compositions to about 10%, about 2%, or even about 1% by weight of the compositions of one or more dye transfer inhibiting agents such as polyvinylpyrrolidone polymers, polyamine N-oxide polymers, copolymers of N-vinylpyrrolidone and N-vinylimidazole, polyvinyloxazolidones and polyvinylimidazoles or mixtures thereof.

### Chelant

The compositions may contain less than about 5%, or from about 0.01% to about 3% of a chelant such as citrates; nitrogen-containing, P-free aminocarboxylates such as ethylenediamine disuccinate (EDDS), ethylenediaminetetraacetic acid (EDTA), and diethylene triamine pentaacetic acid (DTPA); aminophosphonates such as diethylenetriamine pentamethylenephosphonic acid and, ethylenediamine tetramethylenephosphonic acid; nitrogen-free phosphonates e.g., HEDP; and nitrogen or oxygen containing, P-free carboxylate-free chelants such as compounds of the general class of certain macrocyclic N-ligands such as those known for use in bleach catalyst systems.

### Brighteners

The compositions may also comprise a brightener (also referred to as “optical brightener”) and may include any compound that exhibits fluorescence, including compounds that absorb UV light and reemit as “blue” visible light. Non-limiting examples of useful brighteners include: derivatives of stilbene or 4,4′-diaminostilbene, biphenyl, five-membered heterocycles such as triazoles, pyrazolines, oxazoles, imidiazoles, etc., or six-membered heterocycles (coumarins, naphthalamide, s-triazine, etc.). Cationic, anionic, nonionic, amphoteric and zwitterionic brighteners can be used. Suitable brighteners include those commercially marketed under the trade name Tinopal-UNPA-GX® by Ciba Specialty Chemicals Corporation (High Point, N.C.).

### Other Components

Examples of other suitable components include alkoxylated benzoic acids or salts thereof such as trimethoxy benzoic acid or a salt thereof (TMBA); zwitterionic and/or amphoteric surfactants; enzyme stabilizing systems; coating or encapsulating agent including polyvinylalcohol film or other suitable variations, carboxymethylcellulose, cellulose derivatives, starch, modified starch, sugars, PEG, waxes, or combinations thereof; soil release polymers; suds suppressors; dyes; colorants; salts such as sodium sulfate, calcium chloride, sodium chloride, magnesium chloride; photoactivators; hydrolyzable surfactants; preservatives; anti-oxidants; anti-shrinkage agents; other anti-wrinkle agents; germicides; fungicides; color speckles; colored beads, spheres or extrudates; sunscreens; fluorinated compounds; clays; pearlescent agents; luminescent agents or chemiluminescent agents; anti-corrosion and/or appliance protectant agents; alkalinity sources or other pH adjusting agents; solubilizing agents; processing aids; pigments; free radical scavengers, and combinations thereof. Suitable materials include those disclosed in U.S. Pat. Nos. 5,705,464, 5,710,115, 5,698,504, 5,695,679, 5,686,014 and 5,646,101.

### Concentrated Fabric Care Potion

In another aspect of the invention, there is provided a concentrated fabric care potion that comprises a mixture of a fatty amphiphile, in one aspect, a polyglycerol ester, and a fabric softening active. The concentrated fabric care potion can be shipped safely from a remote facility to a new market safely and economically.
In some aspects, the concentrated fabric care potion consists essentially of or consists of a fabric softener active and a mixture of polyglycerol esters, wherein each polyglycerol ester in the mixture of polyglycerol esters has the structure of Formula I

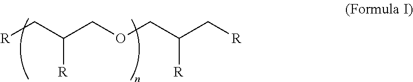

wherein each R is independently selected from the group consisting of fatty acid ester moieties comprising carbon chains having a carbon chain length of from about 10 to about 22 carbon atoms; OH; and combinations thereof;
wherein the mixture of polyglycerol esters has an average value of n ranging from about 1.5 to about 6;
wherein the mixture of polyglycerol esters has an average % esterification ranging from about 20% to about 100%;
wherein greater than or equal to about 50% of the polyglycerol esters in the mixture of polyglycerol esters have at least two ester linkages.
The concentrated fabric care potion generally comprises from about 1% to about 99%, alternatively from about 60% to about 98%, alternatively from about 75% to about 98%, of said fabric softening active by weight of the potion and from about 1% to about 99%, alternatively from about 60% to about 98%, alternatively from about 75% to about 98%, of said mixture of polyglycerol esters by weight of the composition.
In some aspects, the concentrated fabric care potion is substantially free of water. In certain aspects, the concentrated fabric care potion comprises less than about 6% water, alternatively less than about 3% water, alternatively less than about 1% water.
In another aspect, the concentrated fabric care potion comprises a solvent or diluent. In some embodiments, the solvent is selected from ethanol or isopropanol. The solvent may optionally contain a diluent such as propylene glycol, ethylene glycol, glycerol, naturally derived oils, e.g., tallow fat, coconut oil. In some embodiments, there is no solvent or diluent.
In another aspect, the concentrated fabric care potion is free or substantially free of adjunct ingredients. Non-limiting examples of an adjunct ingredient includes a perfume, dye, suds suppressor, or mixture thereof.
Another aspect of the invention provides for a method of making a fabric softener composition comprising the step of adding water to a concentrated fabric care potion of the present invention. In one embodiment, the method further comprises the step of adding one or more adjunct ingredients.

### Treating Fabric and Method of Use

The fabric care compositions of the present invention may be used to treat fabric by administering a dose to a laundry washing machine or directly to fabric (e.g., spray). The compositions may be administered to a laundry washing machine during the rinse cycle or at the beginning of the wash cycle, typically during the rinse cycle. The fabric care compositions of the present invention may be used for handwashing as well as for soaking and/or pretreating fabrics. The fabric care composition may be in the form of a powder/granule, a bar, a pastille, foam, flakes, a liquid, a dispersible substrate, or as a coating on a dryer added fabric softener sheet. The composition may be administered to the washing machine as a unit dose or dispensed from a container (e.g., dispensing cap) containing multiple doses. An example of a unit dose is a composition encased in a water soluble polyvinylalcohol film.

In one aspect, a method of treating and/or cleaning a situs, said method comprising

a) optionally washing and/or rinsing said situs;

b) contacting said situs with a liquid fabric enhancer composition disclosed herein; and

c) optionally washing and/or rinsing said situs.

d) optionally drying said situs via and automatic dryer and/or line drying is disclosed.

### EXAMPLES

The following are non-limiting examples of the fabric care compositions of the present invention as well as comparative compositions.

| | I | II | | | V | | | | |
|---|---|---|---|---|---|---|---|---|---|
| | (comparative) | (comparative) | III | IV | (comparative) | VI | VII | VIII | IX |
| FSA^{a} | 15 | 5 | 6.8 | 5 | 17 | 4.5 | 6.7 | 4.7 | 5.3 |
| PGE^{b} | 0 | 10 | 8.2 | 6 | 0 | 5.6 | 8.4 | 5.7 | 6.3 |
| CTMAC^{c} | 0 | 3 | 0 | 0 | 0 | 0 | 0 | 0 | 0 |
| Tergitol | 0 | 2 | 0 | 0 | 0 | 0 | 0 | 0 | 0 |
| TMN-6 | | | | | | | | | |
| CaCl₂ | 3500 | 1500 | 0 | 0 | 3500 | 1000 | 0 | 175 | 200 |
| (ppm) | | | | | | | | | |
| NaCl | 0 | 0 | 1500 | 1500 | 0 | 0 | 3000 | 0 | 0 |
| (ppm) | | | | | | | | | |
| Depo | 0.25 | 0.25 | 0.25 | 0.80 | 0 | 0 | 0 | 0 | 0 |
| Aid^{d} | | | | | | | | | |
| Anti- | 0.15 | 0.15 | 0.15 | 0.15 | 0 | 0 | 0 | 0 | 0 |
| foam^{e} | | | | | | | | | |
| Chelant^{f} | 0.05 | 0.05 | 0.05 | 0.05 | 0 | 0 | 0 | 0 | 0 |
| Perfume | 2 | 2 | 2 | 2 | 0 | 0 | 0 | 0 | 0 |
| PMC^{g} | 0.35 | 0.35 | 0.35 | 0.35 | 0 | 0 | 0 | 0 | 0 |
| Deionized | Balance | Balance | Balance | Balance | Balance | Balance | Balance | Balance | Balance |
| Water | | | | | | | | | |

^{a}N,N-di(tallowoyloxyethyl)-N,N-dimethylammonium chloride.
^{b}Grinstead PGE 382 (ex Danisco)
^{c}CTMAC = cetyl trimethylammonium chloride
^{d}Poly(ethylene imine) Epomin P1050 (ex Nippon Shokubai)
^{e}Silicone antifoam agent available from Dow Corning ® under the trade name DC2310.
^{f}Diethylenetriamine pentaacetic acid
^{g}Perfume microcapsules available ex Appleton

| (% wt) | X | XI | XII | XIII | XIV | XV | XVI | XVII |
|---|---|---|---|---|---|---|---|---|
| FSA^{a} | 3.8 | 4.6 | 5.3 | 6.3 | 6 | 6.3 | — | — |
| FSA^{b} | — | — | — | — | — | — | 4.8 | — |
| FSA^{c} | — | — | — | — | — | — | — | 5.9 |
| Polyglycerol ester^{d} | 4.9 | 3.4 | 4.7 | 5.7 | 8.3 | 12.7 | 5.8 | 7.1 |
| Structurant^{e,f} | — | 1.2^{e} | — | — | 0.2^{f} | — | 0.2^{f} | 0.2^{f} |
| Perfume | 1.5 | 2.0 | 2.0 | 2.0 | 2.0 | 2.0 | 4 | 2.0 |
| Perfume | 0.6 | 0.3 | 0.3 | 0.3 | 0.4 | — | — | 0.15 |
| encapsulation^{g} | | | | | | | | |
| Phase Stabilizing | 0.25 | — | — | — | — | 0.142 | 1 | 0.25 |
| Polymer^{h} | | | | | | | | |
| Suds Suppressorⁱ | — | — | 0.1 | — | — | — | 0.1 | — |
| Sodium Chloride | 0.15 | 0.15 | — | — | 0.6 | 0.6 | — | 0.15 |
| Calcium | — | — | 200 | 175 | — | — | 750 | — |
| Chloride(ppm) | | | | | | | | |
| DTPA^{j} | 0.005 | 0.005 | 0.005 | 0.005 | 0.005 | 0.005 | 0.005 | 0.005 |
| Preservative (ppm)^{k} | 5 | 5 | 5 | 5 | 5 | 5 | 5 | 5 |
| Antifoam^{l} | 0.015 | 0.15 | 0.15 | 0.15 | 0.11 | 0.011 | 0.015 | 0.011 |
| Polyethylene | 0.15 | 0.25 | 0.15 | 0.15 | — | 0.1 | 0.15 | — |
| imines^{m} | | | | | | | | |
| Cationic | — | — | 0.15 | 0.25 | — | — | 0.15 | — |
| acrylamide | | | | | | | | |
| copolymerⁿ | | | | | | | | |
| Cationic acrylate | 0.25 | — | — | — | 0.2 | 0.05 | — | 0.1 |
| acrylamide | | | | | | | | |
| copolymer^{o} | | | | | | | | |
| PDMS emulsion^{p} | — | — | 3 | — | 1 | 2.0 | — | — |
| Dispersant^{q} | — | — | — | — | 0.5 | 0.2 | — | 0.2 |
| Organosiloxane | 3 | — | — | — | — | — | — | — |
| polymer^{r} | | | | | | | | |
| Amino-functional | — | 5 | — | — | — | — | — | 5 |
| silicone | | | | | | | | |
| Dye ((ppm) | 40 | 11 | — | — | 30 | 40 | 40 | 40 |
| Ammonium | — | — | — | — | — | 0.10 | 0.10 | — |
| Chloride | | | | | | | | |
| Hydrochloric Acid | 0.010 | 0.01 | 0.01 | 0.01 | 0.10 | 0.010 | 0.010 | 0.010 |
| Deionized Water | Balance | Balance | Balance | Balance | Balance | Balance | Balance | Balance |

^{a}N,N-di(tallowoyloxyethyl)-N,N-dimethylammonium chloride.
^{b}Reaction product of fatty acid with methyldiethanolamine in a molar ratio 1.5:1, quaternized with methylchloride, resulting in a 1:1 molar mixture of N,N-bis(stearoyl-oxy-ethyl) N,N-dimethyl ammonium chloride and N-(stearoyl-oxy-ethyl) N,-hydroxyethyl N,N dimethyl ammonium chloride.
^{c}The reaction product of fatty acid with an iodine value of 20 with methyl/diisopropylamine in a molar ratio from about 1.86 to 2.1 fatty acid to amine and quaternized with methyl sulfate.
^{d}Polyglycerol ester Grinstead PGE 382
^{e}Cationic high amylose maize starch available from National Starch under the trade name HYLON VII ®.
^{f}Cationic polymer available from Ciba ® under the name Rheovis ® CDE.
^{g}Perfume microcapsules available ex Appleton
^{h}Copolymer of ethylene oxide and terephthalate having the formula described in U.S. Pat. No. 5,574,179 at col. 15, lines 1-5, wherein each X is methyl, each n is 40, u is 4, each R1 is essentially 1,4-phenylene moieties, each R2 is essentially ethylene, 1,2-propylene moieties, or mixtures thereof.
ⁱSILFOAM ® SE 39 from Wacker Chemie AG.
^{j}Diethylene triamine pentaacetic acid.
^{k}Koralone ™ B-119 available from Dow.
^{l}Silicone antifoam agent available from Dow Corning ® under the trade name DC2310.
^{m}Polyethylene imines available from BASF under the trade name Lupasol ® or from Nippon Shokubai under the tradename Epomin ®
ⁿSedipur CL 541 or Sedipur CL544 from BASF
^{o}Cross-linked Cationic acrylate acrylamide copolymer
^{p}Polydimethylsiloxane emulsion from Dow Corning ® under the trade name DC346.
^{q}Non-ionic surfactant, such as TWEEN 20 ™ or TAE80 (tallow ethoxylated alcohol, with average degree of ethoxylation of 80), or cationic surfactant as Berol 648 and Ethoquad ® C 25 from Akzo Nobel.
^{r}Organosiloxane polymer condensate made by reacting hexamethylenediisocyanate (HDI), and a, w silicone diol and 1,3-propanediamine, N′-(3-(dimethylamino)propyl)-N,N-dimethyl-Jeffcat Z130) or N-(3-dimethylaminopropyl)-N,Ndiisopropanolamine (Jeffcat ZR50) commercially available from Wacker Silicones, Munich, Germany.

| | XVIII | | |
|---|---|---|---|
| | (comparative) | XIX | XX |
| FSA^{a} | 17 | 4.9 | 3.8 |
| PGE^{b} | 0 | 3.4 | 4.5 |
| CaCl₂ (ppm) | 1000 | 350 | 350 |
| Depo Aid 1^{c} | 0.15 | 0.15 | 0.15 |
| Depo Aid 2^{d} | 0.25 | 0.25 | 0.25 |
| Formic Acid | 0.02 | 0.02 | 0.02 |
| preservative^{e} | 0.006 | 0.006 | 0.006 |
| Anti-foam^{f} | 0.15 | 0.15 | 0.15 |
| Chelant^{g} | 0.008 | 0.006 | 0.006 |
| Perfume | 2 | 2 | 2 |
| PMC^{h} | 0.34 | 0.34 | 0.34 |
| Hydrochloric Acid | 0.02 | 0.02 | 0.02 |
| Deionized | Balance | Balance | Balance |
| Water | | | |

^{a}N,N-di(tallowoyloxyethyl)-N,N-dimethylammonium chloride.
^{b}Polyglycerol Ester with average glycerol chain length of 3.4, average esterification of 3.8, esterified with Tallow Fatty Acid, IV 20.
^{c}Poly(ethylene imine) Epomin P1050 (ex Nippon Shokubai)
^{d}Modified cationic acrylamide copolymer Sedipur CL 541 or Sedipur CL544 from BASF
^{e}Proxel GXL available from Arch Chemicals.
^{f}Silicone antifoam agent available from Dow Corning ® under the trade name DC2310.
^{g}Diethylenetriamine pentaacetic acid
^{h}Perfume microcapsules available ex Appleton

Characterization by Differential Scanning calorimetry
The fabric care compositions prepared by the method of this invention are comprised of a gel network that can be characterized by the chain melt temperature of the layer in the gel network comprising the fabric softening active and one or more fatty amphiphiles (i.e., the melt transition temperature for the gel network) and the enthalpy changes in the first cycle of differential scanning calorimetry. The use of DSC to measure the melt transition temperature for gel networks is accepted in the art. See T. de Vringer et al., Colloid and Polymer Science, vol. 265, 448-457 (1987); and H. M. Ribeiro et al., Intl. J. of Cosmetic Science, vol. 26, 47-59 (2004); and M. S. Yoon et al., J. Dispersion Science and Technology, 20(7), 1695-1713 (1999). The maximum change in heat flow of the endothermic peak in the second heating cycle is reported to characterize the melt transition temperature of the raw materials (Table 1). The maximum change in heat flow of the endothermic peak in the first heating cycle, or the local maxima in the change in heat flow when there are multiple melt transitions present is reported to characterize the melt transitions of the structures as made in the dispersions. Compositions of the present invention have multiple melt transitions present that are separated from about 3° C. Without wishing to be bound by theory, the lower melt transition corresponds to the vesicular dispersion, and a higher melt transition that is separated by from about 3° C. corresponds to the gel network structures that are formed from combination of the FSA and fatty amphiphile. The change in heat flow for the higher melting transition can be integrated relative to the entire melt transition to give a relative amount of gel network formed (Table 2). It can be seen from Table 2 that the amount of gel network species can be increased by varying the ratio of cationic fabric softening active to polyglycerol ester and the salt level. Thus, Applicants use Differential Scanning Calorimetry to characterize their compositions.

TABLE 1
Melt Transition, Tm, of DEEDMAC and Grinsted PGE 382 Raw
Materials determined using the DSC Method described below
with the additional steps of cooling to −60° C.
at a rate of −10° C./min, and heating the sample
in a second cycle to 85° C. to obtain the change in
heat flow and thus the melt transition temperature.

| Material | Tm (° C.) |
|---|---|
| DEEDMAC | 41, 55 |
| Grinsted PGE 382 | 51 |

TABLE 2
Melt Transition, Tm, of Fabric Care Compositions Containing Gel Networks

| | | | | | | | Relative |
|---|---|---|---|---|---|---|---|
| | | | CaCl₂ | Tm | ΔH | Higher Tm | Amount of |
| Example | FSA | PGE | (ppm) | (° C.) | (J/g) | ΔH (J/g) | Gel Network |
| Example V | 17 | 0 | 3500 | 49 | 5.07 | N/A | none |
| (comparative) | | | | | | | |
| Example VI | 4.5 | 5.6 | 1000 | 50, 56 | 7.64 | 3.28 | 39% |
| Example VII | 6.7 | 8.4 | 0 | 50, 57 | 10.38 | 4.39 | 33% |
| Example VIII | 4.7 | 5.7 | 175 | 50, 57 | 8.06 | 4.52 | 56% |
| Example IX | 5.3 | 6.3 | 200 | 50, 57 | 7.16 | 4.22 | 59% |

Table 3 shows the differences in freshness and feel performance on fabrics treated with a standard DEEDMAC vesicular control (I), a blend of a DEEDMAC vesicular control and a PGE emulsion made with cetyl trimethylammonium chloride (CTMAC) (II), and fabric care compositions prepared according to the process described herein (III and IV). Freshness on treated fabrics can be determined by sensory evaluation of dry fabric odor intensity (DFO) and rubbed fabric odor (RFO) intensity by expert panelists. Without wishing to be bound by theory, the DFO is primarily representative of the neat perfume on fabrics, and the RFO is primarily representative of the encapsulated perfume on fabrics. Table 3 shows equivalent DFO and RFO for Examples II and III made from a blend of DEEDMAC dispersion with the PGE/CTMAC emulsion, and the process according to the present invention, respectively. Example II has equal freshness performance with 3% less active, namely CTMAC, a quaternary ammonium compound. CTMAC is used to emulsify PGE and it may also function as a softening active or to deliver neat perfume when deposited on fabric. Table 3 also shows higher DFO (+12) and RFO (+5) performance in Example IV than Example III which uses less total feel actives (11% versus 15%, respectively) if a higher level of deposition enhancing agent is used (0.8% versus 0.25%, respectively).
Feel performance can be characterized using the Extraction Energy Test Method, using a Phabrometer instrument, which determines the amount of energy required to extract a cotton cloth, treated or untreated, through an orifice. It requires less energy to extract a cotton terry cloth treated with a rinse-added fabric care composition than to extract an untreated cotton terry cloth. The lesser the extraction energy required, the more lubricous or “silky” a fabric likely feels. Table 3 shows approximately equivalent extraction energies for fabrics treated with the compositions of Examples I (comparative), II (comparative), III, and IV, where Example IV contains less total active, quaternary ammonium compound and PGE, than Example II, the DEEDMAC dispersion blended with a PGE/CTMAC emulsion (11% versus 18%, respectively).

TABLE 3
Olfactive Panel and Extraction Energy Results for
Examples I, II, III, and IV

| | | | Total | FRESH- | | FEEL |
|---|---|---|---|---|---|---|
| | | | Feel | NESS | | Extraction |
| Example | Quat | PGE | Actives | DFO | RFO | Energy |
| I (comparative) | 15.0% | NONE | 15% | 39 | 56 | 62.6 ± 1.3 |
| II (comparative) | 8.0% | 10.0% | 18% | 45 | 66 | 59.7 ± 1.9 |
| III | 6.8% | 8.2% | 15% | 44 | 67 | 62.1 ± 2.5 |
| IV | 5.0% | 6.0% | 11% | 56 | 72 | 65.5 ± 4.6 |

Heat Stability. The fabric softening compositions of the present invention made from a cationic fabric softening active and a fatty amphiphile demonstrate greater heat stability over compositions of cationic fabric softening active alone, namely diester quaternium ammonium compounds. Heat stability is indirectly measured by the relative percentage of the monoester quaternium ammonium species (MEQ) that is released as a result of the hydrolysis of the diester quaternium ammonium species (DEQ), and by fatty acid that is released as a result of the hydrolysis of the MEQ. High performance liquid chromatography (HPLC) is used to assess the percentage of MEQ relative to the total esterquat level (i.e., DEQ+MEQ) using purified DEQ and MEQ calibration standards. The HPLC results of fabric softening compositions of the present invention that have been aged for 4 and 12 weeks at 35° C., 40° C., and 50° C. are presented in Table 4 relative to compositions made from a cationic quaternary ammonium compound alone (Comparative example XVIII). The comparative example XVIII was not measurable beyond 4w of aging at 50° C. because of poor solubility that is believed to be caused by a high level of fatty acid hydrolysis products.

TABLE 4
Characterization of Heat Stability Using HPLC

| | MEQ/(DEQ + MEQ) | | | |
|---|---|---|---|---|
| Example | 12 w/35° C. | 12 w/40° C. | 4 w/50° C. | 12 w/50° C. |
| XVIII | 28.2% | 36.7% | 37.2% | Not Measurable |
| XIX | 16.1% | 22.5% | 18.8% | 68.0% |
| XX | 12.9% | 17.3% | 18.8% | 55.6% |

### Methods

### Method For Determining Melt Transition Temperature

1.) Sample 1. Obtain a 100 g sample of the subject dispersion of cationic fabric softener active and fatty amphiphile that will be used to produce the fluid fabric softener in question.
2.) Sample 2. Prepare a 100 g sample of cationic fabric softener active dispersion using the same process used to produce the sample from 1.) above except without the use of fatty amphiphile. Such sample should have the same active concentration of cationic fabric softener active as the sample from 1 above;
3.) Sample 3. Prepare a 100 g sample of fatty amphiphile dispersion using the same process used to produce the sample from 1.) above except without the use of cationic fabric softener active. Such sample should have the same concentration of fatty amphiphile as the sample from 1 above.
4.) Run Differential Scanning calorimetry on Samples 1, 2 and 3 as follows:
   Differential Scanning calorimetry Method (DSC). Place 3-4 mg of the dispersions to be measured in separate crucibles. Hermetically seal the crucibles to prevent loss of volatiles during the measurement. Run the DSC on each hermetically sealed crucible using a Differential Scanning calorimeter (DSC) such as model Q1000 (V9.8) from TA Instruments Thermal Analysis that is fitted with a Q2000 DSC cell and is equipped with a liquid nitrogen cooling system. Apply a nitrogen purge of 50 mL/min to the sample cell. Calibrate the instrument temperature and cell constant using an indium metal standard provided by TA instruments by heating the indium standard at a rate of 10° C./min. Indium metal is run as a validation of the calibration, verifying the onset of the melt and the heat of the melt (area of the curve). The baseline is calibrated from −50° C. to 300° C. at a heating rate of 10° C./min using a sapphire standard. After calibration, each sample is heated from 20° C. to 85° C. at 10° C./min, is cooled at the same rate down to −60° C., and optionally, the test sample is heated in a second cycle to 85° C. The raw data for each sample is plotted on an X-Y axis, where X represents the temperature and Y axis represents the change in heat flow of the test sample relative to the indium metal standard. The maximum change in heat flow from the plot is recorded and is considered to be the melt transition temperature of the sample. The maximum change in heat flow of the endothermic peak in the first heating cycle, or the local maxima in the change in heat flow when there are multiple melt transitions present, is used to determine the melt transitions of the structures as made in the sample. The melt transitions of each of the samples is compared to determine the difference in melt transition temperature(s).
   Method for Determining Heat Stability in Finished Fabric Softening Samples by Characterizing Hydrolysis Products after Storage at Elevated Temperatures Using HPLC.
   This test can be used to demonstrate the heat stability of a fabric softener composition by measuring the fabric softener composition's relationship with temperature and time.
   Place twelve, 250 ml samples of the fluid fabric softener of interest in 500 ml glass jars. Seal the glass jars with lids (VWR #). Four of such jars containing the fluid fabric softener of interest are aged at 35° C., four of such jars containing the fluid fabric softener of interest are aged at 40° C., four of such jars containing the fluid fabric softener of interest are aged at 50° C. A jar from each temperature condition is removed according to the following schedule: 2w, 4w, 6w, and 12w for analysis by the HPLC method described below to characterize monoester quat (MEQ), diester quat (DEQ), free fatty acid (FFA), and diester amine (DEA) species in the ester quat raw materials and in aqueous dispersions. The ratio of MEQ/(DEQ+MEQ) is used to determine the degree of hydrolysis over time wherein as the ratio of MEQ/(DEQ+MEQ) increases, the amount of hydrolysis increases, thus the stability of the product decreases.
   Quantitative HPLC Method. High pressure liquid chromatography with evaporative light scattering detection is used for the quantitative analysis of monoester quat (MEQ), and diester quat (DEQ) in the ester quat raw materials and in aqueous dispersions of the samples using a suitable HPLC fitted with an evaporative light scattering detector (ELSD) such as the Waters Alliance 2695 HPLC fitted with Waters 2420 ELSD. Sample solutions for analysis are prepared by dissolving a known amount of the sample in a 50:50 chloroform/methanol solution and then diluting the mixture in an equal volume of methanol to give an ester quat concentration of approximately 1 mg/mL. Separation of all species is achieved by injection of 10 microliter aliquot of the sample solution on an RP18 column (for example, a 4.6×150 mm, 3.5 micron, Waters XBridge P/N 186003045) and elution with a mobile phase of water and methanol that is buffered with 10 mM ammonium acetate and 0.1% glacial acetic acid at a flow rate of 1.5 mL/min. The mobile phase gradient is ramped from 80% methanol to 100% methanol over 10 minutes with a hold time of 5 minutes at 100% methanol with a column temperature of 40° C. These conditions allow the desired resolution and complete elution of the MEQ, DEQ, free fatty acid (FFA), and diester amine (DEA) of interest in 15 minutes. Peaks on the ELSD chromatograms corresponding to MEQ, and DEQ are integrated and quantified using log-log external standard calibration curves made from elution of pure monostearate and distearate quat materials over a range of approximately 10-2000 ppm.
   Method for Treatment with a Rinse-Added Fabric Softener Composition. Fabrics are treated with fabric softener compositions of this invention by dispensing the fabric softener into the rinse cycle of a washing machine such as a top loading Kenmore 80 series. Each washing machine contains 2.5 kg of 100% cotton EuroTouch terry towels (40-45 fabrics that are 5.1 cm×5.1 cm) that are available from Standard Textile, 2250 Progress Dr., Hebron, K.Y. The new fabrics are de-sized by washing two times using 119 g HE AATCC detergent per 2.5-2.6 kg load in a top loading washing machine (eg. Kenmore 80 series, Heavy duty cycle), followed by three cycles without detergent. All cycles use zero grain water, and stripped fabrics are tumble dried after the last wash cycle for 55 min on the high setting.
   The stripped fabrics are then treated with fabric softening compositions of the present invention by washing using a medium fill, 17 gallon setting with a 90° F. Wash and 60° F. Rinse using 6 grain per gallon water (the heavy duty cycle in the Kenmore 80 series). Detergent such as Tide Free liquid laundry detergent (49.6 g), is added to the water at the beginning of the cycle. The liquid fabric softener to be tested is pre-dispersed in an equal volume of de-ionized water, and the solution is added to the rinse water during the rinse cycle. The amount of fabric softener composition that is added to the washer is normalized to deliver an equivalent amount of fabric softening active to each washing machine. Fabrics are dried using for example, a Kenmore series dryer, on the cotton/high setting for 50 min.
   Method of Determining Olfactive Performance of Treated Fabrics. The treated fabrics are smelled by an expert grader panel where each panelist is given a separate fabric from the fabric treatment method to evaluate for scent intensity. The expert panel is comprised of 15 to 20 qualified panelists that grade the fabrics for scent intensity using Dry Fabric Odor (DFO) and Rubbed Fabric Odor (RFO) intensity scores on a scale of 0-100 where a “0” score means there is no scent or fragrance on the fabric, a “50” score means there is a moderate scent or fragrance intensity on the fabrics, and a “100” score means there is a high scent or intensity on fabrics (ie. a score of 100 has the strongest odor). The panelists are qualified after correctly detecting the appropriate character and intensity in neat perfume solutions, and correctly detecting the intensity trends in treated fabrics. Panelists perform the character assessment by correctly detecting the same character in 2 of 3 vials of 2% neat perfume solutions in dipropylene glycol, on three types of perfume characters (eg. fruity, woody, floral, etc.). The panelists must correctly rank order the perfume solution intensity of 0.5%, 2%, and 5% perfume solutions in dipropylene glycol in three out of 4 assessments.
   Panelist scores are anchored using untreated fabrics as baseline (0 score), and perfume anchors representing scent strength scores of low (10-30), medium (40-70) and high intensity (80-100). Anchors are made using neat perfume in a water/ethanol base (95%/5%). Neat perfume (15 g) is mixed with Aquasolved (85 g) to solubilize the perfume, then the perfume/Aquasolved mixture is added to the water/ethanol base at different concentrations representing low (0.03% perfume), medium (0.09%), and high (0.27%) intensity levels of the scale. The anchor level solutions are applied to cotton swabs or filter paper strips 15 min before the panel begins. The panelists sniff the swabs to anchor themselves to the intensity scale in the panel.
   The treated fabrics are equilibrated in a constant temperature (CT) room at 70° F./50% relative humidity for a minimum of 24 h before the evaluation. The panels are run in a room designated for panel evaluation in uncontrolled conditions, and test fabrics are equilibrated ion the room for 30 min before the panel begins. Each panelist smells an indivudual treated fabric and records the DFO. The same fabric is rubbed together 6 times, and the panelist smells the fabric again and records the RFO. The score from 20 different treated fabrics are averaged. Panelists smell five different treatment legs, and treatments are randomized between panelists. Each panel includes an internal control treatment (eg. fabrics treated with off the shelf Downy). The higher the averaged score for DFO and RFO, the more intense the scent is on fabrics.
   Method for Determining Softness on Treated Fabrics Using Extraction Energy Test Method (EETM) with a Phabrometer. The EETM is determined using a PhabrOmeter FES3 instrument from Nu Cybertek, Inc. (502 Mace Blvd. #7, Davis, Calif. 95618). Circles of treated fabric are die cut into 11.2 cm circles using ahydraulic press. The fabric curcles are placed between two 32 mm rings on the Phabrometer. The top ring is weighted with 1.36 kg and can be varied based on fabric type. A small probe pushes the fabric through the hole in the ring (perpendicular to the fabric surface). The instrument records the force (as voltage) needed to push the fabric through the ring for a total of 120 data points. The extraction energy is the area under the voltage-time curve plot. Briefly, the EETM suggests that it takes less energy to extract cotton terry cloth treated with rinse added fabric care compositions versus an untreated cotton terry cloth. The lower the extraction energy, the more lubricous or “silky” the fabric likely feels.

Standard measurement conditions employ a 1377 g weight and 5.08 cm hole size. Six replicate fabric samples are measured and averaged to give the reported value. Prior to measurement, fabrics are cut with a dye into circles that have a diameter of 11.2 cm. Fabrics are equilibrated in a constant temperature (CT) room for 24 hours before measuring. The CT room temperature is 70° F. with a relative humidity of 50%. Between each fabric measurement, the bottom of the weight, the inside of the ring, and the base in which the ring is placed are cleaned with an alcohol wipe having 70% isopropyl alcohol and 30% deionized water. The weight and ring are allowed to dry completely before the next measurement. Once measured, a fabric swatch cannot be re-measured.

The first 100 data points of each force-versus-displacement curves are exported to a computer spreadsheet program such as Microsoft Excel®, where they are integrated, and the sum is reported as the unitless “Extraction Energy value.” For each test treatment, a minimum of 6 fabric replicates are evaluated (sampling from as many different terry cloths as possible), averaged, and the sample standard deviation calculated.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of making a fabric care composition comprising the steps of:
a. mixing a molten fabric softener active with a molten mixture of polyglycerol esters to form a first mixture, wherein each polyglycerol ester in the mixture of polyglycerol esters has the structure of Formula I 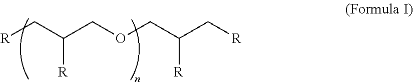
wherein each R is independently selected from the group consisting of fatty acid ester moieties comprising carbon chains having a carbon chain length of from about 10 to about 22 carbon atoms; OH; and combinations thereof;
wherein the mixture of polyglycerol esters has an average value of n ranging from about 1.5 to about 6;
wherein the mixture of polyglycerol esters has an average % esterification ranging from about 20% to about 100%;
wherein greater than or equal to about 50% of the polyglycerol esters in the mixture of polyglycerol esters have at least two ester linkages; and
b. combining the first mixture with water to form a second mixture;
c. combining the second mixture with a material selected from a delivery enhancing agent, an antifoam agent, a chelant, a preservative, a structurant, a silicone, a phase stabilizing polymer, a perfume, a perfume microcapsule, a dispersant, or a combination thereof to form the fabric care composition.

2. A method of making a fabric care composition comprising the steps of:
a. mixing a fabric softener active with a mixture of polyglycerol esters to form a first mixture, wherein each polyglycerol ester in the mixture of polyglycerol esters has the structure of Formula I 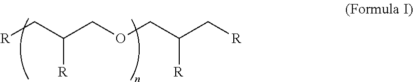
wherein each R is independently selected from the group consisting of fatty acid ester moieties comprising carbon chains having a carbon chain length of from about 10 to about 22 carbon atoms; OH; and combinations thereof;
wherein the mixture of polyglycerol esters has an average value of n ranging from about 1.5 to about 6;
wherein the mixture of polyglycerol esters has an average % esterification ranging from about 20% to about 100%;
wherein greater than or equal to about 50% of the polyglycerol esters in the mixture of polyglycerol esters have at least two ester linkages;
b. melting the first mixture;
c. combining the first mixture with water to form a second mixture; and
d. combining the second mixture with a material selected from a delivery enhancing agent, an antifoam agent, a chelant, a preservative, a structurant, a silicone, a phase stabilizing polymer, a perfume, a perfume microcapsule, a dispersant, or a combination thereof to form the fabric care composition.

3. A method of making a fabric care composition comprising the steps of:
a. melting a fabric softener active;
b. melting a mixture of polyglycerol esters, wherein each polyglycerol ester in the mixture of polyglycerol esters has the structure of Formula I 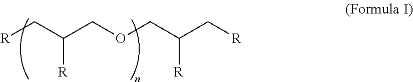
wherein each R is independently selected from the group consisting of fatty acid ester moieties comprising carbon chains having a carbon chain length of from about 10 to about 22 carbon atoms; OH; and combinations thereof;
wherein the mixture of polyglycerol esters has an average value of n ranging from about 1.5 to about 6;
wherein the mixture of polyglycerol esters has an average % esterification ranging from about 20% to about 100%;
wherein greater than or equal to about 50% of the polyglycerol esters in the mixture of polyglycerol esters have at least two ester linkages;
c. simultaneously combining the fabric softening active melt and the polyglycerol ester melt with water to form an aqueous mixture; and
d. combining the aqueous mixture with a material selected from a delivery enhancing agent, an antifoam agent, a chelant, a preservative, a structurant, a silicone, a phase stabilizing polymer, a perfume, a perfume microcapsule, a dispersant, or a combination thereof to form the fabric care composition.

4. The method of claim 1 wherein the first mixture further comprises a dispersant.

5. The method of claim 3 wherein the fabric softening active melt and the polyglycerol ester melt are further combined with a dispersant.

6. A fabric care potion consisting essentially of a fabric softener active and a mixture of polyglycerol esters, wherein each polyglycerol ester in the mixture of polyglycerol esters has the structure of Formula I 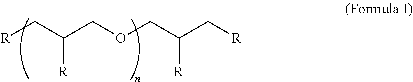
wherein each R is independently selected from the group consisting of fatty acid ester moieties comprising carbon chains having a carbon chain length of from about 10 to about 22 carbon atoms; OH; and combinations thereof;
wherein the mixture of polyglycerol esters has an average value of n ranging from about 1.5 to about 6;
wherein the mixture of polyglycerol esters has an average % esterification ranging from about 20% to about 100%;
wherein greater than or equal to about 50% of the polyglycerol esters in the mixture of polyglycerol esters have at least two ester linkages.

7. The fabric care potion composition of claim 6 wherein the composition is substantially free of water.

8. A fluid fabric softener comprising a composition that comprises, based on total fluid fabric softener weight:
a) from about 2% to about 25% of one or more cationic fabric softening actives; and
b) from about 2% to about 20% of one or more fatty amphiphiles comprising one or more C₁₀-C₂₂ moieties, C₁₆-C₂₀ moieties, or C₁₆-C₁₈ moieties;
said composition having at least one melt transition temperature, that is at least 3° C. higher than the melt transition temperature of individual dispersions of any cationic fabric softening active or amphiphile that is employed in said fluid fabric softener.

9. A fluid fabric softener according to claim 8 wherein said cationic fabric softener active is selected from the group consisting of:
a) linear quaternary ammonium compounds
b) branched quaternary ammonium compounds
c) cyclic quaternary ammonium compounds
d) and mixtures thereof;
said quaternary ammonium compounds comprising:
one or more C₁₀-C₂₂ fatty acid moieties, C₁₆-C₂₀ fatty acid moieties, or C₁₆-C₁₈ fatty acid moieties, said fatty acid moieties having an Iodine value from 0 to about 95;
a counter ion; and
one or more moieties selected from the group consisting of alkyl moieties, ester moieties, amide moieties, and ether moieties said one or more moieties being covalently bound to the nitrogen of said quaternary ammonium compound.

10. A fluid fabric softener according to claim 9 wherein said cationic fabric softening active is selected from the group consisting of:
a) an ester quaternary ammonium compound;
b) an alkylated quaternary ammonium compound;
c) an alkoxylated quaternary ammonium compound; and
d) mixtures thereof.

11. A fluid fabric softener according to claim 10 wherein said amphiphile comprises one or more moieties selected from the group consisting of an alcohol moiety, an ester moiety, an amide moiety and mixtures thereof.

12. A fluid fabric softener according to claim 9 wherein said amphiphile is selected from the group consisting of:
a) a fatty alcohol;
b) an alkoxylated fatty alcohol;
c) a fatty ester;
d) a poly(glycerol ester); and
e) mixtures thereof.

13. A fluid fabric softener according to claim 8, said fluid fabric softener comprising, based on total composition weight, from about 0% to about 0.75% of a salt.

14. A fluid fabric softener according to claim 13, wherein said salt is selected from the group consisting of sodium chloride, potassium chloride, calcium chloride, magnesium chloride and mixtures thereof.

15. A fluid fabric softener according to claim 8, said fluid fabric softener comprising from about from about 0.01% to about 20%, based on total weight of the composition, of a cationic polymer.

16. A fluid fabric softener according to claim 15 where the cationic polymer is selected from the group consisting of polyethyleneimine, alkoxylated polyethleneimine; alkyl polyethyleneimine and quaternized polyethyleneimine, poly(vinylamine), poly(vinylformamide)-co-poly(vinylamine), poly(vinylamine)-co-poly(vinyl alcohol) poly(diallyldimethylammonium chloride), poly(acrylamide-co-diallyldimethylammonium chloride), poly(acrylamide-methacrylamidopropyltrimethyl ammonium chloride), poly(acrylamide-co-N,N-dimethyl aminoethyl acrylate), poly(acrylamide-co-N,N,N-trimethyl aminoethyl acrylate), poly(N,N-dimethyl aminoethyl acrylate), poly(N,N,N-trimethyl aminoethyl acrylate), poly(N,N-dimethyl aminoethyl methacrylate), poly(N,N,N-trimethyl aminoethyl methacrylate), poly(acrylamide-co-N,N-dimethylaminoethyl methacrylate), poly(acrylamide-co-N,N,N-trimethylaminoethyl methacrylate), poly(hydroxyethylacrylate-co-dimethyl aminoethyl methacrylate), poly(hydroxyethylacrylate-co-trimethyl aminoethyl methacrylate), poly(hydroxpropylacrylate-co-methacrylamidopropyltrimethylammonium chloride), poly(acrylamide-co-diallyldimethylammonium chloride-co-acrylic acid), poly(acrylamide-methacrylamidopropyltrimethyl ammonium chloride-co-acrylic acid), poly(vinylpyrrolidone-co-dimethylaminoethyl methacrylate), poly(ethyl methacrylate-co-quaternized dimethylaminoethyl methacrylate), poly(ethyl methacrylate-co-oleyl methacrylate-co-diethylaminoethyl methacrylate), poly(acrylate-co-methacrylamidopropyltrimethylammonium, poly(methacrylate-co-methacrylamidopropyltrimethylammonium, poly(diallyldimethylammonium chloride-co-acrylic acid), poly(vinyl pyrrolidone-co-quaternized vinyl imidazole) and mixtures thereof.

17. The fluid fabric softener of claim 8, said fluid fabric softener comprising a perfume delivery system, and/or a silicone softening agent.

18. A fluid fabric softener according to claim 8, said fluid fabric softener comprising, an adjunct ingredient selected from the group consisting of solvents, chelating agents, dye transfer inhibiting agents, dispersants, polymeric dispersing agents, clay soil removal/anti-redeposition agents, brighteners, suds suppressors, dyes, perfume, benefit agent delivery systems, structure elasticizing agents, carriers, hydrotropes, processing aids and/or pigments, cationic starches, scum dispersants, dye, hueing agent, optical brighteners, antifoam agents, stabilizer, pH control agent, metal ion control agent, odor control agent, preservative, antimicrobial agent, chlorine scavenger, anti-shrinkage agent, fabric crisping agent, spotting agent, anti-oxidant, anti-corrosion agent, bodying agent, drape and form control agent, smoothness agent, static control agent, wrinkle control agent, sanitization agent, disinfecting agent, germ control agent, mold control agent, mildew control agent, antiviral agent, drying agent, stain resistance agent, soil release agent, malodor control agent, fabric refreshing agent, dye fixative, color maintenance agent, color restoration/rejuvenation agent, anti-fading agent, anti-abrasion agent, wear resistance agent, fabric integrity agent, anti-wear agent, and rinse aid, UV protection agent, sun fade inhibitor, insect repellent, anti-allergenic agent, enzyme, flame retardant, water proofing agent, fabric comfort agent, water conditioning agent, shrinkage resistance agent, stretch resistance agent, and mixtures thereof.

19. A method of treating and/or cleaning a situs, said method comprising
a) optionally washing and/or rinsing said situs;
b) contacting said situs with a fluid fabric softener according to claim 8 through 18; and
c) optionally washing and/or rinsing said situs.
d) optionally drying said situs via and automatic dryer and/or line drying.
